(19) United States
(12) Patent Application Publication
(10) Pub. No.: US 2023/0398471 A1
(43) Pub. Date: Dec. 14, 2023

(54) Method and System for Ammonia Recovery

(71) Applicant: Asahi Kasei Kabushiki Kaisha, Tokyo (JP)

(72) Inventors: Akira Kiguchi, Tokyo (JP); Yuki Suga, Tokyo (JP); Mitsuru Fujita, Tokyo (JP)

(73) Assignee: Asahi Kasei Kabushiki Kaisha, Tokyo (JP)

(21) Appl. No.: 18/209,048

(22) Filed: Jun. 13, 2023

(30) Foreign Application Priority Data
Jun. 14, 2022 (JP) 2022-095921
Jun. 14, 2022 (JP) 2022-095931
Jun. 14, 2022 (JP) 2022-096021

(51) Int. Cl. B01D 17/06

(52) U.S. Cl. CPC B01D 17/06

(57) ABSTRACT

An ammonia recovery method which includes electrodialysis of a treatment liquid comprising an ammonium salt and an acid to obtain a recovered acid solution including ammonia-containing recovered ammonia water and an acid, wherein the electrodialysis is carried out by a two-chamber method using a bipolar membrane and an anion exchange membrane.

### FIELD

The present invention relates to a method and system for recovery of ammonia from ammonia-containing waste water.

The invention also relates to a method of operating a volatile solute removal device using a membrane contactor, which allows efficient removal of volatile solutes.

### BACKGROUND

In the volatile solute removal method using a membrane contactor (hereunder referred to as “membrane contactor method”), treatment water containing volatile solutes is contacted with a membrane and the volatile solutes in the water to be treated are selectively passed through the membrane and removed using the difference in vapor pressure of the volatile solutes on either side of the membrane as the driving force. The method for creating a difference in vapor pressure of the volatile solutes on either side of the membrane may be a method in which an absorbing solution is situated on the permeation side to produce a temperature difference or concentration difference between the water to be treated and the absorbing solution, or a method in which the permeation side is brought to a state of reduced pressure. When the volatile solute is a reactive solute or an acidic or basic solute, one known method is to use an absorbing solution that reacts with the volatile solute to lower the vapor pressure of the volatile solute.

By using a membrane, the membrane contactor method increases the area at the gas-liquid interface compared to a stripping method or vacuum degassing method and is therefore advantageous in that the treatment rate can be improved and the apparatus can be made more compact.

In a membrane contactor method, operation is generally carried out by increasing the temperature of the water to be treated to increase vapor pressure difference between the volatile solutes on both sides of the membrane, with the goal of improving the volatile solute removal efficiency. In this case, the water in the water to be treated escapes as water vapor together with the volatile solutes, migrating to the permeation side (PTLs 1 to 3).

However, migration of water vapor in the water to be treated to the permeation side results in loss of latent heat of the water vapor, lowering the temperature of the water to be treated. The vapor pressure of the volatile solutes therefore decreases and this lowers the removal efficiency for volatile solutes. When an absorbing solution is used, water is caused to migrate to the absorbing solution side. This not only dilutes the absorbing solution and reduces absorption efficiency, but also increases the amount of used absorbing solution, thus increasing the waste liquid volume.

One problem when handling treatment water at high concentration by a membrane contactor method is that scales tend to be deposited on the membrane surface. When deposited scales cover the membrane surface, the membrane pores can become clogged, interfering with volatile solute migration and drastically reducing removal performance. In addition, hydrophilization of the membrane surface by scales tends to lead to more infiltration of treatment water to the permeation side and thus lower stability of separation performance by the membrane contactor.

Recent techniques using membranes have advanced greatly from the viewpoint of fluid dynamics.

For example, NPL 1 reported on the relationship between scale deposition onto a membrane and the Reynolds number of the treatment liquid, in a model experiment using a membrane distillation system based on DCMD (Direct Contact Membrane Distillation) using a PVDF (polyvinylidene fluoride) flat sheet membrane.

In NPL 2, a model membrane for a membrane oxygenator is used for discussion of Leveque theory.

Electric power plants based on thermal power generation generate electricity by operation of turbines driven by water vapor produced by a boiler. The water vapor used to drive the turbines is fed to a condenser for conversion to liquid water, the impurity ions being removed by contact with an ion exchange resin in a desalting apparatus, and is then recirculated to the boiler.

Ammonia is added to the water fed to the boiler in order to prevent corrosion. The ammonia is captured in the ion exchange resin of the desalting apparatus, before recirculation to the boiler. When the ion exchange resin in the desalting apparatus is regenerated, the regenerated waste water contains large amounts of ammonia.

A portion of the circulating water may be discharged to eliminate impurities in the water circulated between the boiler and turbines (blowdown). The waste water from blowdown also contains ammonia.

When operation of the electric power plant is halted for long periods, the boiler and turbines, as well as their connecting conduits, are usually filled with “boiler storage water” containing ammonia added to purified water for storage treatment, to prevent corrosion of the equipment. The ammonia-containing boiler storage water must therefore be discharged when the electric power plant is restarted.

When a tank is provided that stores the ammonia for this purpose, the rinsing waste water for the tank also contains ammonia.

For a variety of reasons, therefore, ammonia-containing waste water is generated in electric power plants that are based on thermal power generation. Ammonia-containing waste water is treated, for example, by discharge after diluting the ammonia concentration by mixture with other waste water, or by discharge after removing the ammonia with an ammonia waste water treatment apparatus.

As mentioned above, ammonia is used for a variety of purposes in electric power plants that are based on thermal power generation, but ammonia is also used as a reducing agent for nitrogen oxides in denitrification equipment where exhaust gas discharged from an internal combustion engine of an automobile is treated by denitrification.

Ammonia is therefore in high demand for industrial use and environmental protection.

It has been proposed to reutilize ammonia recovered from ammonia-containing waste water.

PTL 4, for example, proposes contacting air with ammonia-containing waste water discharged from a thermal power plant, bleeding the ammonia into the air and using the obtained ammonia-containing air for denitrification treatment.

PTL 5 proposes adding an alkali to waste water containing ammonia nitrogen, converting the ammonia nitrogen to ammonia, and then recovering the ammonia by stripping.

PTL 6 proposes treating the ammonia in an ammonia-containing gas stream with an acid and subjecting the water flow containing the ammonium salt generated by the treatment to electrodialysis using a three-chamber bipolar electrodialyzer, to recover the acid and ammonia.

### CITATION LIST

### Patent Literature

[PTL 1] Japanese Unexamined Patent Publication HEI No. 06-039367
[PTL 2] Japanese Unexamined Patent Publication HEI No. 06-182325
[PTL 3] Japanese Unexamined Patent Publication HEI No. 06-182326
[PTL 4] Japanese Unexamined Patent Publication HEI No. 8-252596
[PTL 5] Japanese Unexamined Patent Publication HEI No. 9-75915
[PTL 6] Japanese Patent Public Inspection No. 2008-522798

### Non Patent Literature

[NPL 1] Journal of Membrane Science 346 (2010) 263-269
[NPL 2] Journal of chemical engineering of Japan, 18, (1985) 550-555

### SUMMARY

### Technical Problem

Recovery of ammonia has been associated with insufficient recovery efficiency in the prior art, while the high energy consumption required for recovery has also been a problem.

The present invention has been devised in light of the circumstances described above, and its object is to provide a method and system for recovering ammonia from ammonia-containing waste water that has been discharged from a plant, with low cost and high efficiency.

The present invention also discloses:
a method of operating a volatile solute removal device that can solve the problems associated with migration of water into treatment water, and
a method of operating a volatile solute removal device using a hollow fiber membrane as a membrane contactor membrane, wherein both scale deposition on the membrane surface and pressure loss are inhibited.

### Solution to Problem

The present invention is as follows.
<Aspect 1> An ammonia recovery method which includes electrodialysis of a treatment liquid comprising an ammonium salt and an acid to obtain a recovered ammonia water containing ammonia and a recovered acid solution containing an acid, wherein:
the electrodialysis is carried out by a two-chamber method using a bipolar membrane and an anion exchange membrane.
<Aspect 2> The ammonia recovery method according to aspect 1, wherein the treatment liquid is a liquid obtained by contacting an ammonia-containing solution with an acid solution to cause the ammonia in the ammonia-containing solution to migrate into the acid solution.
<Aspect 3> The ammonia recovery method according to aspect 2, wherein the contact between the ammonia-containing solution and the acid solution is carried out using a membrane contactor.
<Aspect 4> The ammonia recovery method according to aspect 3, wherein the membrane of the membrane contactor is a porous hollow fiber membrane.
<Aspect 5> The ammonia recovery method according to aspect 4, wherein:
the average pore diameter of the porous hollow fiber membrane is 0.02 μm to 0.5 μm,
the pore size distribution as the ratio of the maximum pore diameter with respect to the average pore diameter is 1.2 to 2.5, and
the porosity of the porous hollow fiber membrane is 60% to 90%.
<Aspect 6> The ammonia recovery method according to aspect 4, wherein the treatment liquid is flowed to the inside of the porous hollow fiber membrane and the acid solution is flowed to the outside.
<Aspect 7> The ammonia recovery method according to aspect 1, which includes distilling the recovered ammonia water obtained by the electrodialysis to obtain high-concentration ammonia water and distillation residue.
<Aspect 8> The ammonia recovery method according to aspect 7, wherein the treatment liquid is a liquid obtained by contacting an ammonia-containing solution with an acid solution to cause the ammonia in the ammonia-containing solution to migrate into the acid solution.
<Aspect 9> The ammonia recovery method according to aspect 8, wherein the contact between the ammonia-containing solution and the acid solution is carried out using a membrane contactor.
<Aspect 10> The ammonia recovery method according to aspect 9, wherein the membrane of the membrane contactor is a porous hollow fiber membrane.
<Aspect 11> The ammonia recovery method according to aspect 10, wherein:
the average pore diameter of the porous hollow fiber membrane is 0.02 μm to 0.5 μm,
the pore size distribution as the ratio of the maximum pore diameter with respect to the average pore diameter is 1.2 to 2.5, and
the porosity of the porous hollow fiber membrane is 60% to 90%.
<Aspect 12> The ammonia recovery method according to aspect 11, wherein the treatment liquid is flowed to the inside of the porous hollow fiber membrane and the acid solution is flowed to the outside.
<Aspect 13> The ammonia recovery method according to aspect 2, which includes:
distilling the recovered ammonia water obtained by the electrodialysis to obtain high-concentration ammonia water and distillation residue, and mixing the distillation residue with the ammonia-containing solution.
<Aspect 14> The ammonia recovery method according to aspect 13, wherein an alkali is added to the recovered ammonia water before distillation.
<Aspect 15> An ammonia recovery method which includes the following steps in order:
(A) distilling ammonia-containing waste water to obtain recovered ammonia and an ammonia-containing solution as a first distillation residue,
(B) contacting the ammonia-containing solution with an acid solution to cause the ammonia in the ammonia-containing solution to migrate into the acid solution and obtain a treatment liquid,
(C) subjecting the treatment liquid to electrodialysis to obtain a recovered ammonia water containing ammonia and a recovered acid solution containing an acid, and
(D) distilling the recovered ammonia water to obtain high-concentration ammonia water and a second distillation residue.
<Aspect 16> The ammonia recovery method according to aspect 15, wherein steps (A) to (D) are carried out in a cyclical manner.

As a second viewpoint of the invention, the following aspects are disclosed.
<Aspect 17> A method of operating a volatile solute removal device in order to remove a volatile solute from treatment water comprising both a volatile solute and a non-volatile solute using a membrane contactor, which includes:
an absorption step in which
the treatment water is flowed to one side of the membrane contactor, the absorbing solution for the volatile solute is flowed to the other side and the treatment water and the absorbing solution are contacted through the membrane to cause the volatile solute to migrate into the absorbing solution,
for conversion to volatile solute-removed treatment water with a reduced volatile solute concentration and
a volatile solute-containing absorbing solution that contains the volatile solute or its salt,
to remove the volatile solute from the treatment water, wherein:
the temperature of the absorbing solution at the absorbing solution inlet of the membrane contactor is at or above the temperature of the treatment water at the treatment water inlet of the membrane contactor,
the temperature of the absorbing solution at the absorbing solution outlet of the membrane contactor is at or above the temperature of the treatment water at the treatment water outlet of the membrane contactor,
the linear velocity of the absorbing solution in the membrane contactor is slower than the linear velocity of the treatment water in the membrane contactor,
the absorbing solution is recirculated to the membrane contactor, and
the direction of the treatment water flow and the direction of the absorbing solution flow are parallel, and the water vapor pressure difference determined by mathematical formula (18) is −20 kPa to 5 kPa.

Water vapor pressure difference=Water vapor pressure of treatment water at treatment water inlet of membrane contactor−water vapor pressure of absorbing solution at absorbing solution inlet of membrane contactor (18)
<Aspect 18> The operating method according to aspect 17, wherein the water vapor pressure difference is −10 kPa to 1 kPa.
<Aspect 19> The operating method according to aspect 17, wherein the logarithmic mean water vapor pressure difference determined by mathematical formula (19) is −5 kPa to 1 kPa.

Logarithmic mean water vapor pressure difference=[(P_{A1}−P_{B1})−(P_{A2}-P_{B2})]/ln[(P_{A1}−P_{B1})/(P_{A2}-P_{B2})] (19)
P_{A1}: Water vapor pressure of treatment water at treatment water inlet of membrane contactor
P_{A2}: Water vapor pressure of treatment water at treatment water outlet of membrane contactor
P_{B1}: Water vapor pressure of absorbing solution at absorbing solution inlet of membrane contactor
P_{B2}: Water vapor pressure of absorbing solution at absorbing solution outlet of membrane contactor
<Aspect 20> The operating method according to aspect 17, wherein the treatment water is supplied by one pass to the membrane contactor.
<Aspect 21> The operating method according to aspect 17, wherein the membrane used in the membrane contactor is a hydrophobic porous membrane and the maximum pore diameter of the hydrophobic porous membrane is 0.05 μm to 0.5 μm.
<Aspect 22> The operating method according to aspect 17, wherein the membrane of the membrane contactor is a hydrophobic porous hollow fiber membrane.
<Aspect 23> The operating method according to aspect 22, wherein the inner diameter of the hollow fiber membrane is 0.35 mm to 2.0 mm.
<Aspect 24> The operating method according to aspect 17, wherein:
the volatile solute is a volatile basic compound,
the absorbing solution contains an acid, and
the volatile solute-containing absorbing solution contains a salt of the basic compound and the acid.
<Aspect 25> The operating method according to aspect 24, wherein:
the volatile basic compound is ammonia, and
the volatile solute-containing absorbing solution contains a salt of ammonia and the acid.
<Aspect 26> The operating method according to aspect 17, wherein:
the volatile solute is a volatile acidic compound,
the absorbing solution contains a base, and
the volatile solute-containing absorbing solution contains a salt of the acidic compound and the base.
<Aspect 27> The operating method according to aspect 24, which includes, before the absorption step, a step of adding an alkali to the treatment water to adjust the pH of the treatment water to 10 or higher.
<Aspect 28> The operating method according to aspect 24, which further includes, after the absorption step:
an electrodialysis step in which the volatile solute-containing absorbing solution is subjected to electrodialysis to remove the volatile solute from the volatile solute-containing absorbing solution, regenerating an absorbing solution while also obtaining a volatile solute-concentrated water.

As third viewpoint of the invention, the following aspects are disclosed.
<Aspect 29> A method of operating a volatile solute removal device in order to remove a volatile solute from treatment water comprising both a volatile solute and a non-volatile solute using a membrane contactor, wherein:
in a membrane module having a hollow fiber bundle formed of a plurality of hollow fiber membranes,
the membranes used for the membrane contactor are hollow fiber membranes, with treatment water being flowed to the insides of the hollow fiber membranes to remove the volatile solute,
the Reynolds number of the treatment water flowed to the insides of the hollow fiber membranes is 1,100 to 7,000, and
the linear velocity of the treatment water flowed to the insides of the hollow fiber membranes is 3.5 m/s or lower.
<Aspect 30> The operating method according to aspect 29, wherein the Reynolds number of the treatment water flowed to the insides of the hollow fiber membranes is 2,300 or smaller.
<Aspect 31> The operating method according to aspect 29, wherein the linear velocity of the treatment water flowed to the insides of the hollow fiber membranes is 0.4 m/s to 2.0 m/s.
<Aspect 32> The operating method according to aspect 31, wherein the absorbing solution for the volatile solute is flowed to the outside of the hollow fiber membranes, to contact the treatment water and the absorbing solution through the hollow fiber membranes and cause the volatile solute to migrate into the absorbing solution, thereby removing the volatile solute from the treatment water.
<Aspect 33> The operating method according to aspect 29, wherein the outside of the hollow fiber membranes is reduced pressure.
<Aspect 34> The operating method according to aspect 29, wherein the hollow fiber membranes are hydrophobic.
<Aspect 35> The operating method according to aspect 29, wherein the volatile solute contains one or more compounds selected from among ammonia, hydrochloric acid, carbonic acid, acetic acid, alcohols and acetonitrile.
<Aspect 36> The operating method according to aspect 34, wherein:
the volatile solute contains one or more compounds selected from among ammonia, hydrochloric acid, carbonic acid, acetic acid, alcohols and acetonitrile, and
when the volatile solute contains ammonia, the absorbing solution is an aqueous solution of an acid,
when the volatile solute contains one or more compounds selected from among hydrochloric acid, carbonic acid and acetic acid, the absorbing solution is an aqueous solution of a base, and
when the volatile solute contains one or more selected from among alcohols and acetonitrile, the absorbing solution is water.
<Aspect 37> The operating method according to aspect 29, wherein the non-volatile solute contains one or more selected from among amino acids, peptides, proteins, protein preparations, sugars, vaccines, nucleic acids, antibiotics, vitamins, surfactants, antibody-drug conjugates (ADC) and inorganic salts.

### Advantageous Effects of Invention

According to the first viewpoint of the invention there is provided a method and system for recovering ammonia from ammonia-containing waste water that has been discharged from a plant, with low cost and high efficiency.

According to the second viewpoint of the invention there is disclosed a method of operating a volatile solute removal device that can inhibit migration of water during volatile solute removal in a volatile solute removal device employing the membrane contactor method. The operating method can thus inhibit reduction in vapor pressure of the volatile solute that takes place with lowering temperature of the treatment water, reduction in absorption efficiency resulting from dilution of the absorbing solution, and increase in waste liquid volume, thus allowing removal of volatile solutes to be accomplished continuously and more efficiently.

According to the third viewpoint of the invention there is disclosed a method of operating a volatile solute removal device employing the membrane contactor method using hollow fiber membranes, wherein deposition of scales on the membrane surface and excessive pressure loss of treatment water flow can both be inhibited even when carrying out volatile solute removal from treatment water containing large amounts of scale-forming substances. The volatile solute removal device can thus be operated stably at high efficiency for long periods.

### BRIEF DESCRIPTION OF DRAWINGS

FIG. 1 is a conceptual drawing of a system for carrying out the ammonia recovery method according to a preferred mode of the present application.

FIG. 2 is a schematic cross-sectional view illustrating an example of the structure of a membrane contactor membrane module to be applied in the method of the invention.

FIG. 3 is a schematic cross-sectional view illustrating another example of the structure of a membrane contactor membrane module to be applied in the method of the invention.

FIG. 4 is a schematic diagram illustrating an example of the structure of a volatile solute removal device to be applied in the method of the invention.

FIG. 5 is a schematic diagram illustrating another example of the structure of a volatile solute removal device to be applied in the method of the invention.

FIG. 6 is a schematic diagram illustrating yet another example of the structure of a volatile solute removal device to be applied in the method of the invention.

FIG. 7 is a schematic diagram illustrating yet another example of the structure of a volatile solute removal device to be applied in the method of the invention.

FIG. 8 is a schematic diagram illustrating yet another example of the structure of a volatile solute removal device to be applied in the method of the invention.

FIG. 9 is a schematic diagram illustrating yet another example of the structure of a volatile solute removal device to be applied in the method of the invention.

FIG. 10 is a schematic diagram illustrating yet another example of the structure of a volatile solute removal device to be applied in the method of the invention.

FIG. 11 is a graph showing time-dependent change in the state of operation of electrodialysis for Examples 1 and 2.

FIG. 12 is a schematic diagram illustrating the configuration of an apparatus used for measuring pressure loss in a membrane contactor membrane module, for Reference Examples 2-1 to 2-7 and Comparative Reference Examples 2-1 to 2-5.

FIG. 13 is a pair of graphs, one showing the relationship between linear velocity and pressure loss of the treatment water flow and the other showing the relationship between Reynolds number and pressure loss of the treatment water flow, for Reference Example 2-1.

FIG. 14 is a schematic diagram showing the structure of a washing apparatus for washing off of scales deposited on the surfaces of hollow fiber membranes, used for Reference Examples 2-1 to 2-7 and Comparative Reference Examples 2-1 to 2-5.

FIG. 15 is a pair of graphs, one showing the relationship between linear velocity and pressure loss of the treatment water flow and the other showing the relationship between Reynolds number and pressure loss of the treatment water flow, for Reference Example 2-2.

### DESCRIPTION OF EMBODIMENTS

The ammonia recovery method of the invention includes electrodialysis of a treatment liquid comprising an ammonium salt and an acid to obtain a recovered ammonia water containing ammonia and a recovered acid solution containing an acid, wherein:

the electrodialysis is carried out by a two-chamber method using a bipolar membrane and an anion exchange membrane.

The invention discloses the following method of operating a volatile solute removal device.

A method of operating a volatile solute removal device in order to remove a volatile solute from treatment water comprising both a volatile solute and a non-volatile solute using a membrane contactor, which includes:
an absorption step in which
the treatment water is flowed to one side of the membrane contactor, the absorbing solution for the volatile solute is flowed to the other side and the treatment water and the absorbing solution are contacted through the membrane to cause the volatile solute to migrate into the absorbing solution,
for conversion to volatile solute-removed treatment water with a reduced volatile solute concentration and
a volatile solute-containing absorbing solution that contains the volatile solute or its salt,
to remove the volatile solute from the treatment water, wherein:
the temperature of the absorbing solution at the absorbing solution inlet of the membrane contactor is at or above the temperature of the treatment water at the treatment water inlet of the membrane contactor,
the temperature of the absorbing solution at the absorbing solution outlet of the membrane contactor is at or above the temperature of the treatment water at the treatment water outlet of the membrane contactor,
the linear velocity of the absorbing solution in the membrane contactor is slower than the linear velocity of the treatment water in the membrane contactor,
the absorbing solution is recirculated to the membrane contactor, and
the direction of the treatment water flow and the direction of the absorbing solution flow are parallel, the water vapor pressure difference determined by mathematical formula (18) is −20 kPa to 5 kPa.

Water vapor pressure difference=Water vapor pressure of treatment water at treatment water inlet of membrane contactor−water vapor pressure of absorbing solution at absorbing solution inlet of membrane contactor (18)

The invention also discloses the following method of operating a volatile solute removal device.

A method of operating a volatile solute removal device in order to remove a volatile solute from treatment water comprising both a volatile solute and a non-volatile solute using a membrane contactor, wherein:
in a membrane module having a hollow fiber bundle formed of a plurality of hollow fiber membranes,
the membranes used for the membrane contactor are hollow fiber membranes, with treatment water flows into the insides of the hollow fiber membranes to remove the volatile solute,
the Reynolds number of the treatment water flowed to the insides of the hollow fiber membranes is 1,100 to 7,000, and
the linear velocity of the treatment water flowed to the insides of the hollow fiber membranes is 3.5 m/s or lower.

A preferred embodiment of the invention will now be explained in detail as a non-limitative example.

### <Ammonia Recovery Method>

The first viewpoint of the invention relates to an ammonia recovery method that includes electrodialysis of a treatment liquid comprising an ammonium salt and an acid to obtain a recovered ammonia water containing ammonia and a recovered acid solution containing an acid.

The treatment liquid supplied to electrodialysis in the ammonia recovery method of the invention may be an acid solution containing an ammonium salt, obtained by contacting an ammonia-containing solution with an acid solution and causing the ammonia in the ammonia-containing solution to migrate into the acid solution, for example. The contact between the ammonia-containing solution and the acid solution may be carried out using a membrane contactor. The “ammonia-containing solution” may be ammonia-containing waste water discharged from a plant, for example, or distillation residue obtained by distillation of ammonia-containing waste water.

High-concentration ammonia water may also be recovered by distillation of recovered ammonia water obtained by the aforementioned electrodialysis. The pH may also be adjusted by adding an alkali to ammonia-containing waste water or recovered ammonia water before distillation of the ammonia-containing waste water or recovered ammonia water.

### <Volatile Solute Removal Device>

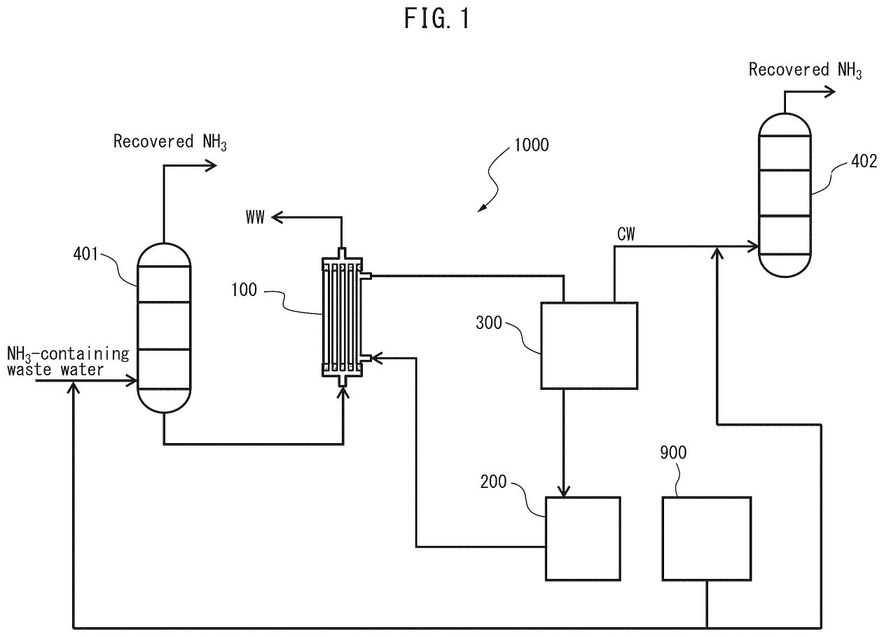

The volatile solute removal device for carrying out the preferred ammonia recovery method of the invention will now be described in detail with reference to FIG. 1.

The volatile solute removal device (1000) of FIG. 1 has a membrane contactor (100), an absorbing solution tank (200), an electrodialysis unit (300), two distillation units (401, 402) and an alkali solution tank (900). The pumps, valves and sensors are not depicted in FIG. 1.

The volatile solute removal device (1000) may also further comprise a flow regulator, pressure regulator and thermal insulation structure, as necessary.

In the method for ammonia recovery using the volatile solute removal device (1000) of FIG. 1, ammonia is recovered from ammonia-containing waste water that has been discharged from a thermal power plant, for example.

The alkali is added to the ammonia-containing waste water from the alkali solution tank (900) to adjust the pH to 10 to 13, for example. Most of the ammonia in the pH-adjusted ammonia-containing waste water distills off at the first distillation unit (401), yielding recovered NH₃ from the tower top and first distillation residue from the tower bottom.

Since the first distillation residue obtained at the first distillation unit (401) still contains ammonia at significant concentration, the ammonia is further recovered from the first distillation residue, in the following manner.

The first distillation residue obtained by the first distillation unit (401) is fed to the membrane contactor (100). Acid solution is stored as absorbing solution in the absorbing solution tank (200), and the acid solution is fed from the absorbing solution tank (200) to the membrane contactor (100).

The first distillation residue and acid solution contact via the membranes in the membrane contactor (100). The residual ammonia in the first distillation residue is thus absorbed into the acid solution as an ammonium salt and recovered. The first distillation residue obtained after the ammonia has been recovered is discharged out of the system as waste water (WW).

The acid solution containing the ammonium salt and acid is then fed to the electrodialysis unit (300) and provided for electrodialysis treatment. Electrodialysis treatment yields an ammonia concentrate (CW) and an acid concentrate (not shown).

The ammonia concentrate (CW) has an alkali added from the alkali solution tank (900), and after adjustment of the pH between 10 and 13, it is fed to the second distillation unit (402). At the second distillation unit (402), high-purity recovered NH₃ is obtained from the tower top while the second distillation residue is obtained from the tower bottom.

According to the method of the invention, high-purity recovered NH₃ is obtained from the tower top of the first distillation unit (401) and the tower top of the second distillation unit (402), and in total this results in a very high yield.

The second distillation residue obtained from the tower bottom of the second distillation unit (402) may contain small amounts of ammonia. Therefore, the second distillation residue may be recirculated and mixed with the ammonia-containing solution which is the first distillation residue, and again supplied for the method of the invention.

The most preferred embodiment for the mode of use of the ammonia recovery method of the invention was described above. However, the scope of the invention is not limited to this preferred embodiment, and is only delimited by the Claims.

The elements of the ammonia recovery method of the invention will now be explained in order.

The volatile solute removal device (1000) shown in FIG. 1 is highly suitable as an apparatus for ammonia recovery. The volatile solute removal device (1000) of FIG. 1 can also be suitably applied as a volatile solute removal device, in light of the second and third viewpoints of the invention.

### (Electrodialysis)

The present invention relates to an ammonia recovery method that includes electrodialysis of a treatment liquid comprising an ammonium salt and an acid to obtain a recovered ammonia water containing ammonia and a recovered acid solution containing an acid.

The electrodialysis of the invention can be carried out using a bipolar electrodialysis unit.

The bipolar electrodialysis unit has a construction comprising a base chamber and an acid recovery chamber partitioned by a bipolar membrane and an anion exchange membrane, formed by arranging the bipolar membrane and anion exchange membrane in a staggered fashion across a chamber frame with a clamping frame disposed and clamped at both ends, a cathode and anode formed at the respective ends, and a power supply that applies voltage between the electrodes. A treatment liquid is filled into the base chamber, while an acid recovery liquid is filled into the acid recovery chamber and an electrode solution is filled into the cathode chamber and anode chamber. Another preferred construction is one in which a liquid inlet and outlet are provided for each chamber to allow liquid circulation with a pump. In this case the cathode chamber liquid and anode chamber liquid will be linked. Specifically, the bipolar electrodialysis unit may be an ACILYZER 02B, 10B, 25B, 50B or EX3B (all trademarks of Astom Corp.). A cationic membrane and alkali recovery chamber are added in an apparatus used for recovery of acids or alkalis.

A bipolar membrane is an ion-exchange membrane having a combined structure comprising an anion exchange layer and cation exchange layer, whereby application of voltage at or above the theoretical decomposition voltage of water can electrolyze water to generate an acid and alkali.

The cation exchange group of the cation exchange membrane forming the bipolar membrane is not particularly restricted, and it may be a publicly known cation exchange group such as a sulfonic acid or carboxylic acid group, for example. From the viewpoint of usage of the bipolar membrane of the invention, a sulfonic acid group is especially preferred, since the exchange group dissociates even under acidic conditions. The anion exchange group of the anion exchange membrane forming the bipolar membrane is also not particularly restricted and may be a publicly known anion exchange group such as an ammonium salt group, pyridinium salt group, or primary amino, secondary amino or tertiary amino group, for example. An ammonium salt group is especially preferred since the exchange group dissociates even under basic conditions.

This type of bipolar membrane may be produced by any of various publicly known methods. Examples of bipolar membrane production methods include:
a method in which a cation exchange membrane and an anion exchange membrane are attached together with a polyethyleneimine-epichlorohydrin mixture and bonded by curing,
a method in which a cation exchange membrane and an anion exchange membrane are bonded with an ion-exchange adhesive,
a method in which a cation exchange membrane and an anion exchange membrane are contact bonded across a coating layer of a paste mixture comprising a fine powder ion exchange resin, an anion or cation-exchange resin and a thermoplastic substance,
a method in which a pasty substance comprising vinylpyridine and an epoxy compound is coated onto the surface of the cation exchange membrane and irradiated with radiation,
a method in which a sulfonic acid-type polymer electrolyte and an allylamine are adhered to the surface of an anion exchange membrane, and then irradiated with ionizing radiation for crosslinking,
a method in which there is deposited on the surface of an ion-exchange membrane, a mixture of a base polymer and a dispersed system of an ion exchange resin of opposite charge,
a method in which a sheet obtained by impregnating and polymerizing styrene and divinylbenzene on a polyethylene film, is inserted between stainless steel frames and sulfonated on one side, and then the sheet is removed and the remaining portion is subjected to chloromethylation and then to amination treatment, and
a method in which a specific metal ion is coated onto the surface of an anion exchange membrane and a cation exchange membrane, and both ion-exchange membranes are stacked and pressed.

The base material of the bipolar membrane may be set as appropriate for the type of cation exchange membrane and anion exchange membrane to be joined. Examples of base materials include films, nets, knitted fabrics, woven fabrics and nonwoven fabrics composed of polyethylene, polypropylene, polyvinyl chloride and styrene-divinylbenzene copolymers.

NEOSEPTA BP-1E (trademark of Astom Corp.) is an example of a commercially available bipolar membrane.

The anion exchange membrane may be any type of membrane, and examples include a membrane obtained by introducing a quaternary ammonium group into a base membrane of a styrene and divinylbenzene copolymer, a membrane obtaining by introducing a quaternary ammonium group into a base membrane of a styrene-butadiene copolymer, a membrane obtained by graft polymerization of styrene onto a polyolefin film and introduction of a quaternary ammonium group, and a membrane comprising a copolymer of tetraethylene and a perfluorovinyl ether having a quaternary ammonium group on the side chain.

Examples of commercially available anion exchange membranes include NEOSEPTA ACM, NEOSEPTA AM-1, NEOSEPTA ACS, NEOSEPTA ACLE-5P, NEOSEPTA AHA, NEOSEPTA AMH and NEOSEPTA ACS (all trademarks of Astom Corp.), SELEMION AMV, SELEMION AMT, SELEMION DSV, SELEMION AAV, SELEMION ASV, SELEMION AHT and SELEMION APS (all trademarks of AGC Corp.), FAB and FAA (trademarks of Fumatech Co.), and ACIPLEX A-501, A-231 and A-101 (all trademarks of Asahi Kasei Corp.).

BP electrodialysis using a bipolar membrane is known as a suitable method for decomposing a salt into an acid and alkali for recovery. Common BP electrodialysis methods are the two-chamber method and three-chamber method.

In the three-chamber method, electrodialysis is carried out using a combination of a bipolar membrane, an anion membrane and a cation membrane. An advantage of the three-chamber method is that it allows the acid and alkali to be recovered simultaneously. However, the membrane cost is high, and electric power may also be high depending on the degree of dissociation of the acid and alkali.

The two-chamber method, on the other hand, is a method of recovering only either an acid or alkali. For recovery of an acid, a bipolar membrane and anion membrane are used in combination, while for recovery of an alkali, a bipolar membrane and cation membrane are used in combination. Using the two-chamber method is therefore advantageous as it can reduce membrane cost, and can also reduce electric power cost for recovery in the case of treating ion species with high degrees of dissociation. The method of the invention allows the advantages of the two-chamber method to be obtained because the ion species recovered by electrodialysis have high degrees of dissociation.

An alkali solution that has high conductivity and does not generate poisonous gas upon voltage application may be used as the electrode solution. An example of such an alkali solution is a 4 mass % concentration sodium hydroxide aqueous solution.

A neutral salt solution with a high degree of dissociation can be used if an alkali needs to be avoided for any particular reason. An example of a neutral salt solution is a sodium sulfate aqueous solution.

The electrode solution is preferably separately prepared as an electrode solution for the anode side and an electrode solution for the cathode side, with each flowed in isolation. When the membrane used has no problems in terms of permeation of nonionic substances and non-selective ions, however, the same solution may be flowed on both the anode side and cathode side, either in series or in parallel.

The ion species recovery solution may be ion-free distilled water, or it may be an aqueous solution in which the ion species to be recovered is dissolved to a prescribed concentration. Such an aqueous solution is preferred to allow efficient operation at a high current value from the start of electrodialysis. For small-scale operation, however, there is no problem with using distilled water since the current value increases rapidly.

The operating temperature for electrodialysis may generally be set as appropriate in consideration of the type of electrodialysis unit and the heat-resistant limit of the ion-exchange membrane. The suitable operating temperature will differ depending on the type of membrane and the manufacturer of the apparatus, but when using the electrodialysis unit used for the Examples described below (EX3B ACILYZER by Astom Corp.) it is preferably 5° C. to 40° C.

According to the invention, electrodialysis by the two-chamber method is preferred from the viewpoint of electrodialysis unit cost, operating time, power consumption and purity of recovered ammonia.

### (Membrane Contactor)

The treatment liquid supplied to electrodialysis in the ammonia recovery method of the invention may be an acid solution containing an ammonium salt, obtained by contacting an ammonia-containing solution with an acid solution, as the absorbing solution, and causing the ammonia in the ammonia-containing solution to migrate into the acid solution, for example. The contact between the ammonia-containing solution and the acid solution may be carried out using a membrane contactor.

The membrane contactor membrane in the membrane contactor of the invention may be a hydrophobic porous membrane that allows the ammonia in the ammonia-containing solution to selectively pass through the membrane and migrate to the acid solution side, by the driving force of the difference in ammonia vapor pressure on the feed side and the permeate side of the membrane, produced when the ammonia-containing solution and the acid solution are contacted through the membrane.

A preferred mode of the volatile solute removal device used in the ammonia recovery method of the invention will now be described in detail. The volatile solute removal device can also be suitably applied as a volatile solute removal device, in light of the second and third viewpoints of the invention.

The membrane contactor of the invention may be in the form of a membrane contactor membrane module, for example, comprising membrane contactor membranes housed in a suitable housing.

In this case the housing interior is partitioned into two chambers by the membrane contactor membranes, with flow between the two chambers being blocked except for permeation of minute components through the pores of the membrane contactor membranes.

The housing is selected from the viewpoint of chemical resistance, pressure resistance, heat resistance, impact resistance and weather resistance. The material forming the housing is preferably selected from among synthetic resins such as polypropylene, polysulfone, polyethersulfone, polyvinylidene fluoride, ABS resins, fiber-reinforced plastic and vinyl chloride resins, and metals such as stainless steel, brass and titanium.

It is desirable for the adhesive resin to have high mechanical strength and heat resistance at 100° C. Examples of adhesive resins include thermosetting epoxy resins and thermosetting urethane resins. Epoxy resins are preferred from the viewpoint of heat resistance. Urethane resins are preferred from the viewpoint of handleability.

The shapes of the membrane contactor membranes may be flat sheet or hollow fiber. When hollow fiber membranes are used, the membrane surface area per volume of the membrane contactor increases, and it becomes easier to uniformly flow the ammonia-containing solution and acid solution throughout the entire membranes inside the membrane contactor.

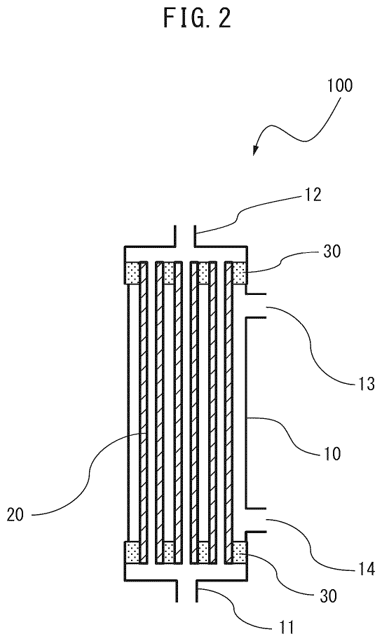

FIG. 2 is a schematic cross-sectional view illustrating an example of a membrane contactor membrane module structure that is preferably applied in the method of the invention.

The membrane contactor membrane module (100) of FIG. 2 has a hollow fiber membrane bundle comprising a plurality of hollow fiber membranes (20) housed in a cylindrical housing (10), with both ends of each hollow fiber membrane (20) anchored to the housing (10) by an adhesive resin layer (30). Both ends of each hollow fiber membrane (20) are open without blockage.

The interior of the membrane contactor membrane module (100) is partitioned by the hollow fiber membranes into a space on the hollow section sides of the hollow fiber membranes and a space on the exterior space sides of the hollow fiber membrane. The two spaces are blocked from mutual flow, except that either or both volatile solutes and water vapor can pass back and forth through the membrane walls of the hollow fiber membranes.

The housing (10) has a treatment water inlet (11) and a treatment water outlet (12) respectively at both ends of the cylindrical form, the structure being such that treatment water (such as ammonia-containing solution) enters into the membrane contactor membrane module (100) through the treatment water inlet (11), passing through the inside of each hollow fiber membrane (20) and being discharged out of the membrane contactor membrane module (100) through the treatment water outlet (12).

The housing (10) also has an absorbing solution inlet (13) and an absorbing solution outlet (14) on the side walls of the cylindrical form, the structure being such that absorbing solution (such as acid solution) enters into the membrane contactor membrane module (100) through the absorbing solution inlet (13), passing outside of each hollow fiber membrane (20) and being discharged out of the membrane contactor membrane module (100) through the absorbing solution outlet (14).

The membrane contactor membrane module (100) may be used for removal of volatile solutes in the following manner, for example.

As an example, treatment water enters into the membrane contactor membrane module (100) through the treatment water inlet (11) and passes through the hollow section of each hollow fiber membrane (20), being flowed and thus discharged through the treatment water outlet (12), while absorbing solution enters into the membrane contactor membrane module (100) through the absorbing solution inlet (13) and passes on the outside of each hollow fiber membrane (20), being flowed and thus discharged through the absorbing solution outlet (14). The volatile solute vapor generated from the treatment water which has high volatile solute vapor pressure then passes through the membrane wall of each hollow fiber membrane (20) and migrates into the absorbing solution which has low volatile solute vapor pressure, being drawn out together with the absorbing solution through the absorbing solution outlet (14), whereby volatile solute removal from the treatment water (that is, migration of volatile solutes into the absorbing solution) takes place. A temperature difference may be created between the treatment water and absorbing solution to increase the vapor pressure difference.

The membrane contactor membrane module (100) of FIG. 2 is constructed so that the treatment water and absorbing solution are flowed in inside and outside each of the hollow fiber membranes countercurrently. However, the construction may also be such that the treatment water and absorbing solution are in cocurrent flow inside and outside each of the hollow fiber membranes.

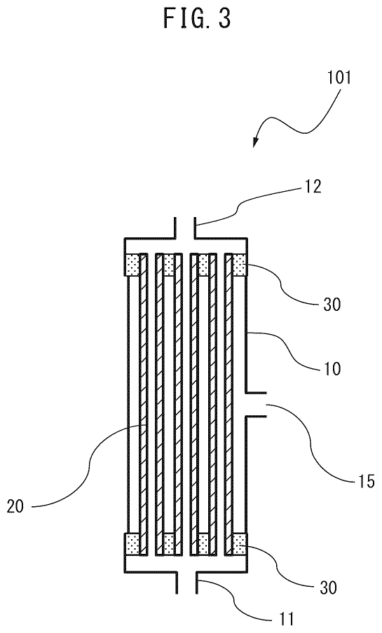

FIG. 3 is a schematic cross-sectional view illustrating another example of a membrane contactor membrane module structure that is preferably applied in the method of the invention.

The membrane contactor membrane module (101) of FIG. 3 is the same as the membrane contactor membrane module (100) of FIG. 2 in that:
a hollow fiber membrane bundle made of a plurality of hollow fiber membranes (20) is housed inside a cylindrical housing (10),
both ends of each hollow fiber membrane (20) are anchored to the housing (10) by the adhesive resin layer (30),
the interior of the membrane contactor membrane module (100) is partitioned by the hollow fiber membranes into a space on the hollow section sides of each of the hollow fiber membranes and a space on the exterior space sides of each of the hollow fiber membranes, and
the housing (10) has a treatment water inlet (11) and a treatment water outlet (12) on the respective ends of the cylindrical form.

However, the membrane contactor membrane module (101) of FIG. 3 differs from the membrane contactor membrane module (100) of FIG. 2 in that it has a volatile solute vapor extraction outlet (15) instead of an absorbing solution inlet and absorbing solution outlet, on the side wall of the cylindrical form.

In the membrane contactor membrane module (101) of FIG. 3, a vacuum pump, for example, is connected to the volatile solute vapor extraction outlet (15) via a coalescer, as necessary. As a result, the region on the outsides of the hollow fiber membranes is depressurized, and volatile solutes that have volatilized from the treatment liquid through the hollow fiber membranes and migrated to the outsides of the hollow fiber membranes are removed out, thereby accomplishing volatile solute removal from the treatment water (that is, migration of the volatile solutes into the absorbing solution).

When the membrane contactor membrane module (100) of FIG. 2 and the membrane contactor membrane module (101) of FIG. 3 are applied for the ammonia recovery method of the invention, the ammonia (volatile solute) in the ammonia-containing solution (treatment water) migrates into the acid solution (absorbing solution), yielding an ammonium salt-containing acid solution. The ammonium salt-containing acid solution may then be supplied to the electrodialysis described above. The acid in the acid solution is preferably one that is water-soluble and non-volatile, while also being a strong acid with as large a dissociation constant as possible, considering efficiency in the subsequent electrodialysis. From this viewpoint, sulfuric acid is most preferably used as it is a non-volatile strong acid and relatively inexpensive.

The ammonia-containing solution from which the ammonia has been removed may then be removed out of the system as waste water.

### <Membrane Contactor Membrane>

The membrane contactor membrane of the invention is preferably composed of a hydrophobic porous membrane.

The membrane contactor membrane used for the invention may be a membrane made of a porous material with a high hydrophobic property.

A porous membrane is a membrane having pores (communicating pores) running through from one surface of the membrane to the other surface in the thickness direction. The pores may be network gaps in the membrane material (such as a polymer), and they may be branching or direct pores. The pore may also allow passage of vapor while blocking liquid.

The membrane contactor membrane is preferably porous, and the membrane wall interiors only allow passage of either or both volatile solutes and water vapor without infiltration of liquid water into the membrane wall interiors.

From the viewpoint of avoiding wetting of the membranes, the porous membrane as the membrane contactor membrane used for the invention has a water contact angle on the surface of at least one side, of preferably 90° or greater, more preferably greater than 90°, even more preferably 110° or greater and most preferably 120° or greater. There is no upper limit for the membrane water contact angle in terms of the effect exhibited by the invention, but realistically it may be 150° or smaller.

The water contact angle, for the purpose of the present specification, is the value measured by the droplet method according to JIS R 3257. Specifically, 2 μL of purified water is dropped onto the surface of an object to be measured, and the angle formed between the object to be measured and the droplet is analyzed from a projection image and digitized.

The membrane contactor membrane used for the invention preferably exhibits a water contact angle in the aforementioned range over essentially all of the region of the surface on one side.

The hydrophobicity of the membrane contactor membrane can also be estimated by measuring the liquid entry pressure of water through the membrane walls. The liquid entry pressure for the treatment water is preferably 0.1 MPa to 2.0 MPa and more preferably 0.2 MPa to 1.5 MPa.

The average pore diameter of the porous membrane is preferably in the range of 0.02 μm to 0.5 μm, and more preferably in the range of 0.03 μm to 0.3 μm. If the average pore diameter is 0.02 μm. In or greater the vapor permeation resistance will not excessively increase, and permeation of the ammonia vapor generated from the ammonia-containing solution will be more rapid. If the average pore diameter is 0.5 μm or smaller, the suppressive effect against membrane wetting will be satisfactory. The average pore diameter is the value measured by the half-dry method according to ASTM:F316-86.

From the viewpoint of both vapor permeability and wetting inhibition, the membrane preferably has a narrower pore size distribution. Specifically, the pore size distribution as the ratio of the maximum pore diameter to the average pore diameter is preferably in the range of 1.2 to 2.5 and more preferably in the range of 1.2 to 2.0. The maximum pore diameter is the value measured using the bubble point method.

The porosity of the porous membrane is preferably in the range of 60% to 90% from the viewpoint of both high vapor permeability and long-term durability. In order to obtain high vapor permeability, the porosity of the porous hollow fiber membrane is preferably 60% or greater and more preferably 70% or greater. From the viewpoint of satisfactorily maintaining the membrane strength and helping to prevent problems such as fracture during prolonged use, the porosity of the porous hollow fiber membrane is preferably 90% or lower, more preferably 85% or lower and even more preferably 80% or lower.

The porosity of the porous membrane is the value calculated from the ratio of the true specific gravity and the apparent specific gravity of the material forming the membrane.

From the viewpoint of obtaining an efficient concentration rate, the surface porosity of the porous membrane is preferably 15% or greater, more preferably 18% or greater and even more preferably 20% or greater, and from the viewpoint of satisfactorily maintaining strength of the membrane itself and helping to avoid problems such as fracture during prolonged use, it is preferably 60% or lower, more preferably 55% or lower and even more preferably 50% or lower, on each surface.

The surface porosity is the value determined by using image analysis software to detect holes in an observation image taken with a scanning electron microscope (SEM) on the membrane surface.

The material forming the porous membrane may be a material including at least one type of resin selected from the group consisting of polysulfone, polyethersulfone, polyethylene, polypropylene, polyvinylidene fluoride, polytetrafluoroethylene, ethyleneethylene tetrafluoride copolymer and polychlorotrifluoroethylene. From the viewpoint of producing a membrane with excellent hydrophobicity, mechanical durability and thermal durability, with a high degree of high film formability, the preferred materials are polyvinylidene fluoride, ethyleneethylene tetrafluoride copolymer and polychlorotrifluoroethylene.

As one aspect of the invention, the porous membrane used may have a hydrophobic polymer adhering to at least a portion thereof, for improved membrane hydrophobicity. A hydrophobic polymer is a polymer that can form a hydrophobic coating film on the surface or membrane interior of at least one side of the porous membrane, imparting water-repellency to the membrane or increasing the water-repellency of the membrane.

As used herein, “hydrophobic polymer” means a polymer with low affinity for water, and for example, it may be a polymer with a hydrophobic structure. The hydrophobic structure may be a non-polar group, low polar group, non-polar backbone or low polar backbone. Examples of non-polar groups or low polar groups include hydrocarbons and fluorinated compounds. Examples of non-polar backbones or low polar backbones include hydrocarbon main chains and siloxane main chains.

Examples of hydrophobic polymers include polymers with siloxane bonds and fluorine atom-containing polymers, and more specifically the following:
(a) Polymers with siloxane bonds, such as dimethylsilicone gels, methylphenylsilicone gels, reactive modified silicone gels with organic functional groups (amino groups or fluoroalkyl groups), and silicone-based polymers that form crosslinked structures by reaction with silane coupling agents, as well as polymer gels which are their crosslinked products, and
(b) Fluorine atom-containing polymers, such as polymers having fluorine atom-containing groups on side chains, where the fluorine atom-containing groups are (per)fluoroalkyl, (per)fluoropolyether, alkylsilyl or fluorosilyl groups.

Particularly preferred as hydrophobic polymers are polymers of one or more monomers selected from among (meth)acrylate-based monomers and vinyl-based monomers having one or more groups selected from among 1 to 12 carbon atoms (per)fluoroalkyl and (per)fluoropolyether groups.

The hydrophobic polymer may also be adhering to the entirety of the pores of the porous membrane.

From the viewpoint of preventing infiltration of liquid into the pores and ensuring vapor permeability, however, preferably the hydrophobic polymer adhesion has a distribution in the thickness direction of the porous membrane, with most of the polymer adhering to the surface layer of the membrane which is in contact with the liquid and less adhesion at the interior in the thickness direction of the membrane, thus maintaining the pore structure.

From this viewpoint, adhesion of the hydrophobic polymer is preferably such that adhesion at the surface layer on at least one side of the porous membrane is greater than adhesion at the interior, more preferably decreasing from the surface layer on one side of the porous membrane toward the membrane interior.

The term “surface layer of the membrane” means the location of the membrane that is in contact with the liquid, and its vicinity. In quantitative terms, it is the region of about 10 μm from the outermost layer of the membrane toward the interior in the membrane thickness direction. The “membrane interior”, on the other hand, refers to locations of the membrane not in contact with liquid and where vapor alone passes through, i.e. locations other than the surface layer of the membrane.

In order to cause adhesion of the hydrophobic polymer onto the porous membrane, a coating solution of the hydrophobic polymer dissolved in a suitable solvent may be applied or sprayed onto the membrane, and then dried. The desired hydrophobic polymer distribution can be obtained by appropriately adjusting the coating location, the volatility (boiling point) of the coating solution solvent, the concentration of the hydrophobic polymer in the coating solution and the drying conditions after coating. When coating is by an immersion process, for example, the coating solution containing the hydrophobic polymer can migrate better in the membrane surface direction during the drying step the lower the volatility of the solvent in the coating solution (the lower the boiling point) and the more gentle the drying conditions are after coating, thus allowing a distribution to be created in the thickness direction of the membrane.

The hydrophobic polymer concentration in the hydrophobic polymer solution used in the hydrophobic polymer adhering step is preferably within a predetermined range. Specifically, the polymer concentration is preferably 0.2 to 5.0 mass %, more preferably 0.4 to 4.0 mass % and even more preferably 0.6 to 3.0 mass %.

If the polymer concentration is 0.2 mass % or greater there will be no lack of the polymer after the polymer has been distributed throughout the membrane, and the membrane will be thoroughly hydrophobized without non-polymer-adhering sections. If the polymer concentration is 5.0 mass % or lower, the void portions of the membrane will not be filled with the polymer, and the porosity of the membrane will be maintained after drying, thus helping to avoid reduction in the vapor permeation rate.

The membrane contactor membrane in the hollow fiber membrane contactor used for the invention is preferably a porous hollow fiber membrane.

The thickness of the porous hollow fiber membrane used as the membrane contactor membrane for the invention is preferably 10 μm to 1,000 μm and more preferably 20 μm to 500 μm, from the viewpoint of both vapor permeability and the mechanical strength of the membrane. A membrane thickness of 1,000 μm or smaller can provide high vapor permeability, while a membrane thickness of 10 μm or greater will allow the membrane to be used without deformation.

The outer diameter of the porous hollow fiber membrane is preferably 300 μm to 5,000 μm and more preferably 350 μm to 4,000 μm, and the inner diameter of the hollow fiber membrane is preferably 200 μm to 4,000 μm and more preferably 250 μm to 3,000 μm.

According to the invention, the form of the membrane contactor membrane module may be that of a flat sheet or hollow fiber membrane contactor membrane packed into a suitable housing, for use as a membrane contactor.

When the membrane contactor membrane is a flat sheet membrane, the flat sheet membrane may be pleated or spiraled to obtain a membrane contactor membrane module with the membrane contactor membrane more efficiently housed in the housing.

When the membrane contactor membrane is a hollow fiber type, a plurality of the hollow fiber membrane contactor membranes may be bundled as a membrane bundle and packed into a suitable module to obtain the membrane contactor membrane module.

The shape of the housing may be cylindrical, polygonal columnar or another polyhedron-type of shape, but there is no particular restriction on the shape.

Preferably, the membrane contactor membrane module has a structure with the hollow fiber membrane bundle housed in the cylindrical or polygonal columnar housing so that the lengthwise direction of the hollow fibers coincide with the axial direction of the housing, with both ends of the hollow fiber bundle anchored in the housing with an appropriate adhesive resin. In this case, the hollow fiber bundle is preferably anchored with the adhesive resin in a fluid-tight manner so that the inner and outer fluid channels of the hollow fiber membrane do not mix.

It is desirable for the adhesive resin to have high mechanical strength and heat resistance at 100° C. Examples of adhesive resins include thermosetting epoxy resins and thermosetting urethane resins. Epoxy resins are preferred from the viewpoint of heat resistance. Urethane resins are preferred from the viewpoint of handleability.

The method of adhesive anchoring may be a bonding method that is known for fabrication of porous membrane modules.

The length (effective length) of the hollow fiber membrane is preferably 500 mm or greater and more preferably 1,000 mm or greater, from the viewpoint of increasing the efficiency for volatile solute removal. From the viewpoint of inhibiting pressure loss, on the other hand, the length of the hollow fiber membrane is preferably 4,000 times or less and more preferably 3,500 times or less, compared to the inner diameter of the hollow fiber membrane.

In formulas (6) to (8) shown below, the full length of the hollow fiber membrane, rather than the effective length, is used as the length L (m) of the hollow fiber membrane when evaluating the pressure loss ΔP (Pa). In other words, when a hollow fiber membrane is used as a membrane contactor membrane module, the length L (m) of the hollow fiber membrane in formulas (6) to (8) is the effective length of the hollow fiber membrane plus the combined thicknesses of the two adhesive resin layers.

### (Distillation)

In the ammonia recovery method according to the first viewpoint of the invention, the ammonia-containing solution supplied to the membrane contactor may be, for example, the distillation residue obtained by distillation of the ammonia-containing waste water discharged from the plant, by the first distillation unit.

Alternatively, the recovered ammonia water obtained by electrodialysis may be distilled by the second distillation unit and recovered as high-concentration ammonia water.

The first distillation unit is used to separate ammonia from the ammonia-containing waste water. The second distillation unit is used to separate ammonia from the recovered ammonia water. Since precise distillation is not required in either of these distillation processes, it is possible to use a simple distillation unit, a thin-film distillation unit or a membrane distillation unit.

The first and second distillation units used for the invention are preferably membrane distillation units from the viewpoint of distillation efficiency, and most preferably they are membrane distillation modules having the same configuration as the membrane contactor membrane module.

The pH may also be adjusted by addition of an alkali to the ammonia-containing waste water and recovered ammonia water prior to the first and second distillation units. This will convert the ammonium salts in the ammonia-containing waste water and recovered ammonia water into ammonia, thus improving distillation efficiency.

According to the invention, the first and second distillation units may be provided as separate units. However, the embodiments of the invention also include providing a single common distillation unit, with recovered ammonia water obtained from the electrodialysis unit being distilled in admixture with the ammonia-containing waste water, for increased efficiency.

According to another viewpoint of the invention there is provided an ammonia recovery method which includes the following steps in order:
(A) distilling ammonia-containing waste water to obtain recovered ammonia and an ammonia-containing solution as a first distillation residue,
(B) contacting the ammonia-containing solution with an acid solution to cause the ammonia in the ammonia-containing solution to migrate into the acid solution and obtain a treatment liquid,
(C) subjecting the treatment liquid to electrodialysis to obtain a recovered ammonia water containing ammonia and a recovered acid solution containing an acid, and
(D) distilling the recovered ammonia water to obtain high-concentration ammonia water and a second distillation residue.

In this case, step (D) may be followed by an additional step:
(E) mixing the second distillation residue with the ammonia-containing solution.

In this ammonia recovery method, steps (A) to (D) or steps (A) to (E) are preferably repeated in a cyclical manner.

The details of each step in the ammonia recovery method are those for the ammonia recovery method described above.

This process allows very high quality ammonia to be obtained in a continuous manner.

According to yet another viewpoint of the invention there is provided an ammonia recovery system.

The apparatus for ammonia recovery of the invention is a system for carrying out the ammonia recovery method described above, as an ammonia recovery system which includes:
(a) a distillation unit for distilling ammonia-containing waste water to obtain recovered ammonia and an ammonia-containing solution as a first distillation residue,
(b) a contactor for contacting the ammonia-containing solution with an acid solution to cause the ammonia in the ammonia-containing solution to migrate into the acid solution and obtain a treatment liquid, and
(c) an electrodialysis unit for subjecting the treatment liquid to electrodialysis to obtain a recovered ammonia water containing ammonia and a recovered acid solution containing an acid.

The details of each device in the ammonia recovery system of the invention are those described above for the ammonia recovery method of the invention.

### <Additional Example for Volatile Solute Removal Device>

An example of a device suitable as a volatile solute removal device for the second and third viewpoints, to be suitably applied in the ammonia recovery method according to the first viewpoint of the invention, was described above in regard to the volatile solute removal device (1000) of FIG. 1.

Another preferred example of a volatile solute removal device for the first to third viewpoints of the invention will now be described.

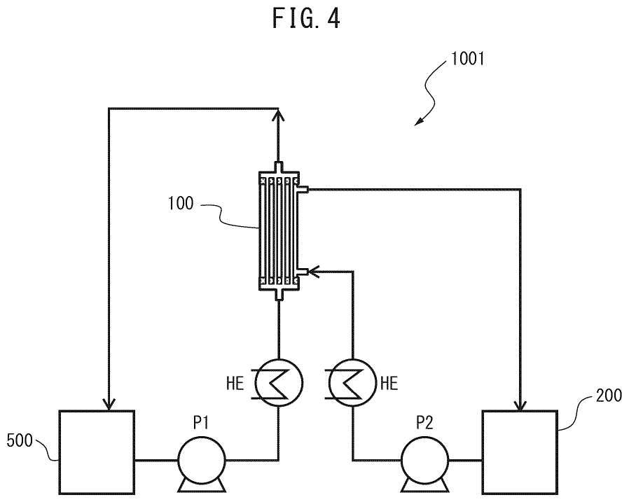

The volatile solute removal device (1001) of FIG. 4 comprises the membrane contactor membrane module (100) shown in FIG. 2 and an absorbing solution tank (200).

In the volatile solute removal device (1001), treatment water stored in a treatment water tank (500) is sent to the membrane contactor membrane module (100) by a treatment water supply pump (P1). After having passed into the hollow section of the hollow fiber membrane in the membrane contactor membrane module (100), the treatment water returns to the treatment water tank (500) and is circulated. Before being introduced into the membrane contactor membrane module (100), the treatment water is heated by a heat exchanger (HE) (such as a heater) and increased in vapor pressure to facilitate volatile solute removal. The tubing sections before and after the membrane contactor membrane module (100) are provided with thermometers (not shown).

The volatile solute removal device (1001) of FIG. 4 also comprises an absorbing solution tank (200). The absorbing solution stored in the absorbing solution tank (200) is fed to the membrane contactor membrane module (100) by an absorbing solution supply pump (P2). After having passed the outside of the hollow fiber membranes in the membrane contactor membrane module (100), the absorbing solution returns to the absorbing solution tank (200) and is circulated. The absorbing solution is heated or cooled by the heat exchanger (HE) before being introduced into the membrane contactor membrane module (100). The vapor pressure of the volatile solute is thus adjusted to facilitate volatile solute removal.

The tubing sections before and after the membrane contactor membrane module (100) are provided with thermometers (not shown).

In the volatile solute removal device (1001) having such a structure, the treatment water and absorbing solution contact across the membrane contactor membranes in the membrane contactor membrane module (100). The volatile solute in the treatment water thus passes through the membrane contactor membranes and migrates into the absorbing solution, thus removing the volatile solute from the treatment water.

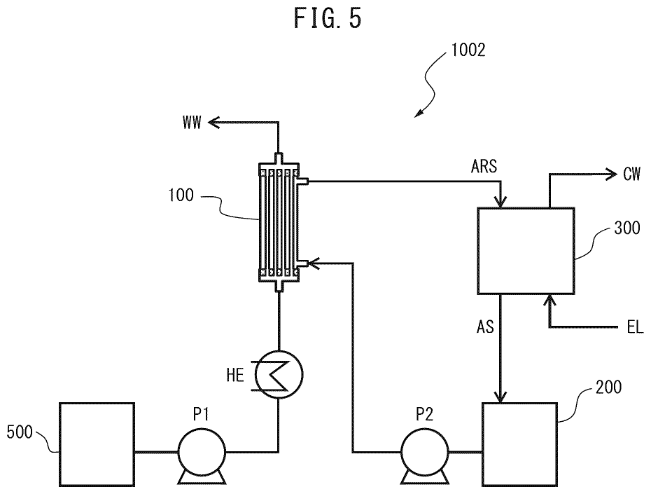

The volatile solute removal device (1002) of FIG. 5 is another example of a device for removal of a volatile solute from treatment water containing a non-volatile solute and a volatile solute.

The volatile solute removal device (1002) of FIG. 5 may be suitably applied in cases where, for example:

the volatile solute is a volatile basic compound,
the absorbing solution contains an acid, and
the volatile solute-containing absorbing solution contains a salt of a basic compound and an acid; or
the volatile solute is a volatile acidic compound,
the absorbing solution contains a base, and
the volatile solute-containing absorbing solution contains a salt of an acidic compound and a base.

An example of the former case will now be explained in terms of the structure and function of the volatile solute removal device (1002).

The volatile solute removal device (1002) comprises the membrane contactor membrane module (100) shown in FIG. 2, an absorbing solution tank (200), and an electrodialysis unit (300).

In the volatile solute removal device (1002), treatment water containing a basic compound as the volatile solute is fed to the membrane contactor membrane module (100) and passes through the insides of the hollow fiber membranes in the membrane contactor membrane module (100), after which it is discharged out of the system as waste water (ww) containing no basic compound.

The acid-containing absorbing solution, on the other hand, is fed to the membrane contactor membrane module (100) and passes outside of the hollow fiber membranes in the membrane contactor membrane module (100), then becoming the volatile solute-containing absorbing solution (ARS) containing the salt of a basic compound and an acid, which is fed to the electrodialysis unit (300).

At the electrodialysis unit (300), the salt of a basic compound and an acid present in the volatile solute-containing absorbing solution (ARS) are separated into the basic compound and the acid. As a result, the absorbing solution is regenerated and returned to the absorbing solution tank (200) as regenerated absorbing solution (AS), and the volatile solute-concentrated water (CW) with the concentrated volatile solute (basic compound) is discharged out of the system.

With this construction, the acid concentration of the absorbing solution can be maintained while efficiently removing the volatile solute from the treatment water. The need for disposing of used absorbing solution is also eliminated, allowing the waste liquid volume to be reduced. In addition, the acid concentration in the absorbing solution can be set lower, helping to reduce the effect of lower vapor pressure caused by the acid.

In FIG. 5, the electrodialysis unit (300) is a type in which the electrode solution (EL) and volatile solute-containing absorbing solution (ARS) are supplied and the volatile solute-concentrated water (CW) and regenerated absorbing solution (AS) are discharged, but there is no limitation to the type of electrodialysis unit (300).

The function of the volatile solute removal device (1002) was described above for an example where the volatile solute is a volatile basic compound and the absorbing solution contains an acid, but a person skilled in the art will be able to refer to the aforementioned description and properly understand the function of the volatile solute removal device (1002) even in cases where the volatile solute is a volatile acidic compound and the absorbing solution contains a base.

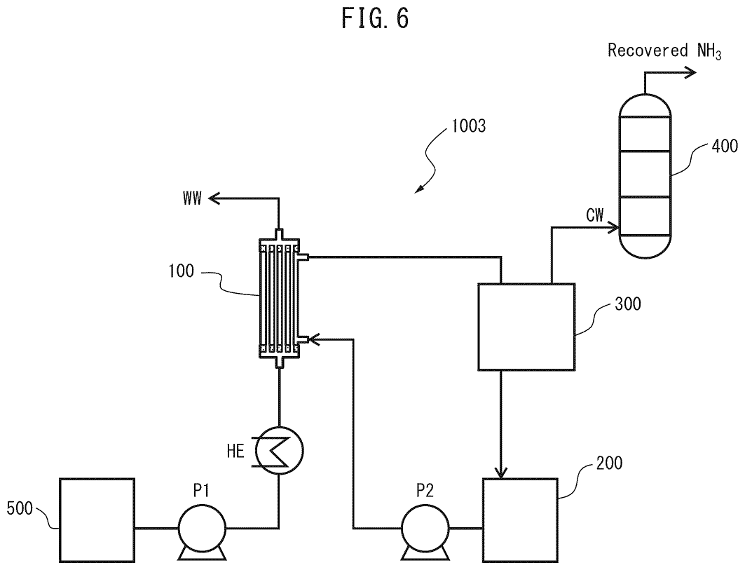

The volatile solute removal device (1003) of FIG. 6 is yet another example of a device for removal of a volatile solute from treatment water containing a non-volatile solute and a volatile solute.

Similar to the volatile solute removal device (1002) of FIG. 5, the volatile solute removal device (1003) of FIG. 6 may also be suitably applied in cases where, for example:
the volatile solute is a volatile basic compound,
the absorbing solution contains an acid, and
the volatile solute-containing absorbing solution contains a salt of a basic compound and an acid; or
the volatile solute is a volatile acidic compound,
the absorbing solution contains a base, and
the volatile solute-containing absorbing solution contains a salt of an acidic compound and a base.

The structure and function of the volatile solute removal device (1003) will now be described for an example where the volatile solute is ammonia and the absorbing solution contains an acid.

The volatile solute removal device (1003) comprises the membrane contactor membrane module (100) shown in FIG. 2, an absorbing solution tank (200), an electrodialysis unit (300) and a distillation unit (400).

In the volatile solute removal device (1003), treatment water containing ammonia as the volatile solute is fed to the membrane contactor membrane module (100) and passes through the insides of the hollow fiber membranes in the membrane contactor membrane module (100) where the ammonia is removed, after which it is discharged out of the system as waste water (WW).

The acid-containing absorbing solution, on the other hand, is fed to the membrane contactor membrane module (100) and passes outside of the hollow fiber membrane in the membrane contactor membrane module (100), then becoming the volatile solute-containing absorbing solution containing a salt (ammonium salt) of ammonia and an acid, which is fed to the electrodialysis unit (300).

At the electrodialysis unit (300), the ammonium salt in the absorbing solution is separated into ammonia and an acid. The absorbing solution is thus regenerated and is returned to the absorbing solution tank (200). At the same time, the volatile solute-concentrated water (CW) with concentrated ammonia is fed to the distillation unit (400).

At the distillation unit (400), the volatile solute-concentrated water (CW) with concentrated ammonia is distilled to obtain recovered ammonia (recovered NH₃) as high-concentration ammonia water.

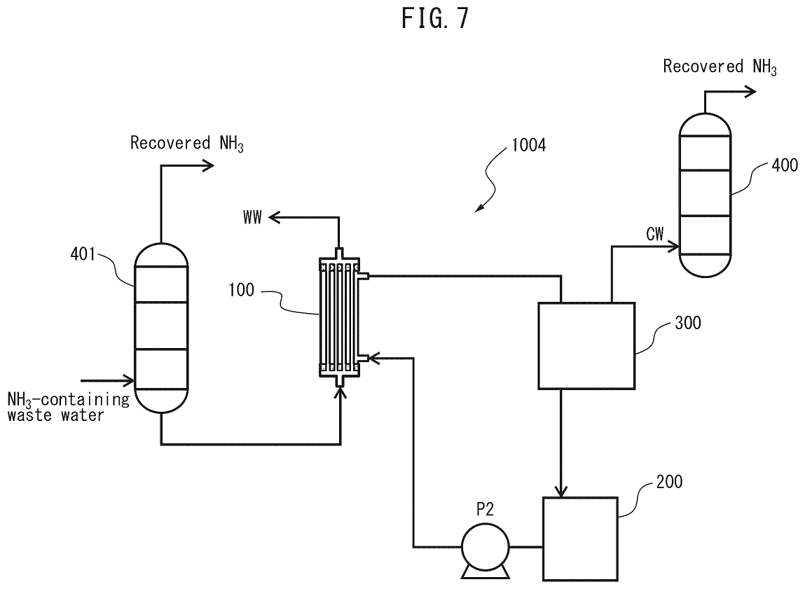

The volatile solute removal device (1004) of FIG. 7 is yet another example of a device for removal of a volatile solute from treatment water containing a non-volatile solute and a volatile solute.

The volatile solute removal device (1004) of FIG. 7 has a construction that is especially preferred for when the volatile solute is ammonia and the absorbing solution contains an acid, wherein the ammonia concentration of the treatment water is lowered before the absorption step.

The volatile solute removal device (1004) has the construction of the volatile solute removal device (1003) shown in FIG. 6, further provided with a distillation unit (401) at the upstream end from the membrane contactor membrane module (100).

The ammonia-containing aqueous solution (NH₃-containing aqueous solution) as raw water is first introduced into the distillation unit (401), and the distillation residue liquid from which ammonia was removed by distillation is fed to the membrane contactor membrane module (100) as treatment water of the invention. The rest of the construction and function are the same as the volatile solute removal device (1003) shown in FIG. 6.

With the volatile solute removal device (1004) it is possible to efficiently remove ammonia from an ammonia-containing aqueous solution, while also allowing high-purity ammonia to be recovered as high-concentration ammonia water by the two distillation units (400, 401).

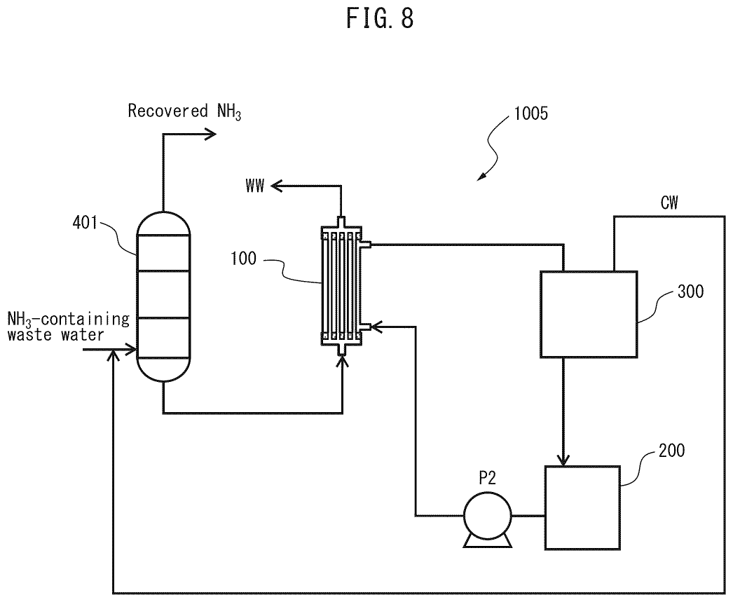

The volatile solute removal device (1005) of FIG. 8 is yet another example of a device for removal of a volatile solute from treatment water containing a non-volatile solute and a volatile solute.

The volatile solute removal device (1005) of FIG. 8 has a construction that is especially preferred for when the volatile solute is ammonia and the absorbing solution contains an acid, and it has the construction of the volatile solute removal device (1004) of FIG. 7, wherein instead of feeding the volatile solute-concentrated water obtained from the electrodialysis unit (CW) to the distillation unit (400), it is mixed with an ammonia-containing aqueous solution (NH₃-containing aqueous solution) as raw water, and introduced into the distillation unit (401).

With this construction it is possible to very efficiently remove ammonia from an ammonia-containing aqueous solution while also allowing high-purity ammonia to be efficiently recovered as high-concentration ammonia water by a centralized distillation unit (401).

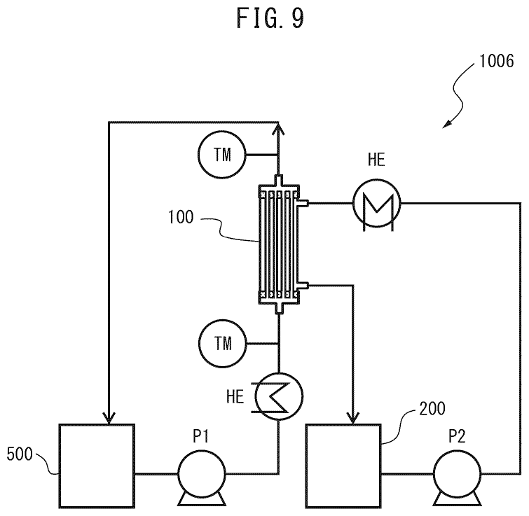

The volatile solute removal device (1006) of FIG. 9 is an example of a device for removal of a volatile solute from treatment water containing a non-volatile solute and a volatile solute.

The volatile solute removal device (1006) of FIG. 9 incorporates the membrane contactor membrane module (100) shown in FIG. 2.

In the volatile solute removal device (1006), treatment water stored in a treatment water tank (500) is sent to the membrane contactor membrane module (100) by a treatment water supply pump (P1). After having passed into the hollow sections of the hollow fiber membranes in the membrane contactor membrane module (100), the treatment water returns to the treatment water tank (500) and is circulated. Before being introduced into the membrane contactor membrane module (100), the treatment water is heated by a heat exchanger (HE) (such as a heater) and increased in vapor pressure to facilitate volatile solute removal. The tubing sections before and after the membrane contactor membrane module (100) are provided with thermometers (TM).

The volatile solute removal device (1006) of FIG. 9 also comprises an absorbing solution tank (200). The absorbing solution stored in the absorbing solution tank (200) is fed to the membrane contactor membrane module (100) by an absorbing solution supply pump (P2). After having passed the outside of the hollow fiber membrane in the membrane contactor membrane module (100), the absorbing solution returns to the absorbing solution tank (200) and is circulated. The absorbing solution is heated or cooled by the heat exchanger (HE) before being introduced into the membrane contactor membrane module (100). The vapor pressure of the volatile solute is thus adjusted to facilitate volatile solute removal.

The tubing sections before and after the membrane contactor membrane module (100) are provided with thermometers (TM).

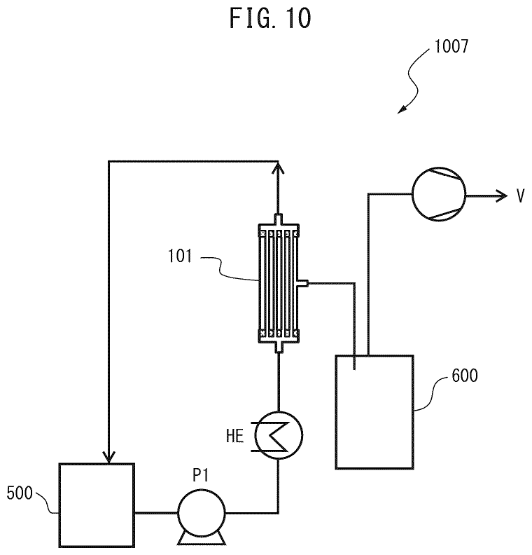

The volatile solute removal device (1007) of FIG. 10 is another example of a device for removal of a volatile solute from treatment water containing a non-volatile solute and a volatile solute.

The volatile solute removal device (1007) of FIG. 10 incorporates the membrane contactor membrane module (101) shown in FIG. 3. The space on the outsides of the hollow fiber membranes of the membrane contactor membrane module (101) is connected with the volatile solute vapor extraction outlet, and with a vacuum pump (V) via a coalescer (600).

With this construction, a vapor pressure difference for the volatile solute is created between the outside of the hollow fibers and the treatment water flowing inside the hollow fibers, thereby allowing removal of the volatile solutes that have volatilized from the treatment liquid, passed through the hollow fiber membrane and migrated to the outside of the hollow fiber membranes. It is thus possible to remove the volatile solute from the treatment liquid.

The volatile solute removal devices of FIG. 4 to FIG. 10 (1001, 1002, 1003, 1004, 1005, 1006, 1007) may each also further comprise a flow regulator, pressure regulator and thermal insulation structure, as necessary.

### <Second Viewpoint of the Invention>

The second viewpoint of the invention is a method of operating a volatile solute removal device in order to remove a volatile solute from treatment water comprising both a volatile solute and a non-volatile solute using a membrane contactor, which includes:
an absorption step in which
the treatment water is flowed to one side of the membrane contactor, the absorbing solution for the volatile solute is flowed to the other side and the treatment water and the absorbing solution are contacted through the membrane to cause the volatile solute to migrate into the absorbing solution,
for conversion to volatile solute-removed treatment water with a reduced volatile solute concentration and
a volatile solute-containing absorbing solution that contains the volatile solute or its salt,
to remove the volatile solute from the treatment water, wherein:
the temperature of the absorbing solution at the absorbing solution inlet of the membrane contactor is at or above the temperature of the treatment water at the treatment water inlet of the membrane contactor,
the temperature of the absorbing solution at the absorbing solution outlet of the membrane contactor is at or above the temperature of the treatment water at the treatment water outlet of the membrane contactor,
the linear velocity of the absorbing solution in the membrane contactor is slower than the linear velocity of the treatment water in the membrane contactor,
the absorbing solution is recirculated to the membrane contactor, and
the direction of flow of the treatment water and the direction of flow of the absorbing solution are parallel, and the water vapor pressure difference determined by mathematical formula (18) is −20 kPa to 5 kPa.

Water vapor pressure difference=Water vapor pressure of treatment water at treatment water inlet of membrane contactor−water vapor pressure of absorbing solution at absorbing solution inlet of membrane contactor (18)

The volatile solute removal device to be applied according to the second viewpoint of the invention includes a membrane contactor.

The volatile solute removal device may further include, in addition to the membrane contactor, one or more components selected from among a distillation unit and an electrodialysis unit. The distillation unit may have one or two components selected from among a pre-distillation unit installed upstream from the membrane contactor, and a post-distillation unit installed downstream from the membrane contactor.

The volatile solute removal device may further include a treatment water tank for housing of the treatment water, an absorbing solution tank for housing of the absorbing solution, an electrode solution to be used for electrodialysis, a tank for housing of the recycled liquid, tubing for fluid communication between each of the units and tanks, valves for opening and closing of the tubing flow channels, pumps for liquid conveyance and a heat exchanger, as well as a thermometer, pressure gauge, pH sensor or other analyzer for monitoring the state of operation.

An example of a typical construction of the volatile solute removal device to be applied according to the second viewpoint of the invention is the following:
a construction that includes a membrane contactor, a treatment water tank, an absorbing solution tank, tubing connecting them and pumps for liquid conveyance, wherein the treatment water can be circulated from the treatment water tank through the membrane contactor and returned to the treatment water tank, and the absorbing solution can be circulated from the absorbing solution tank through the membrane contactor as a volatile solute-containing absorbing solution, and then returned to the absorbing solution tank;
a construction that includes a membrane contactor, an electrodialysis unit, a treatment water tank, an absorbing solution tank, tubing connecting them and pumps for liquid conveyance, wherein the treatment water can be circulated from the treatment water tank through the membrane contactor, and the absorbing solution can be circulated from the absorbing solution tank to the membrane contactor as a volatile solute-containing absorbing solution, and then circulated through a dialysis unit to regenerate absorbing solution from which volatile solute has been removed, and returned to the absorbing solution tank;
a construction that includes a membrane contactor, an electrodialysis unit, a distillation unit, a treatment water tank, an absorbing solution tank, tubing connecting them, and pumps for liquid conveyance, wherein the treatment water can be circulated from the treatment water tank through the membrane contactor, the absorbing solution can be circulated from the absorbing solution tank through the membrane contactor as a volatile solute-containing absorbing solution, and then circulated through a dialysis unit to regenerate absorbing solution from which volatile solute has been removed, and returned to the absorbing solution tank, and the volatile solute-concentrated water obtained from the dialysis unit is fed to the distillation unit; and
a construction that further includes a distillation unit upstream from the membrane contactor in any of the aforementioned constructions, wherein the distillation residue fraction obtained from the distillation unit can be fed to the membrane contactor.

In the method of operating a volatile solute removal device according to the second viewpoint of the invention,
the treatment water and absorbing solution are in a cocurrent flow, and the water vapor pressure difference calculated by the following mathematical formula (18) is −20 kPa to 5 kPa.

Water vapor pressure difference=Water vapor pressure of treatment water at treatment water inlet of membrane contactor−water vapor pressure of absorbing solution at absorbing solution inlet of membrane contactor (18)

In the method of operating a volatile solute removal device according to the second viewpoint of the invention, an excessively low water vapor pressure difference causes water in the absorbing solution to migrate into the treatment water, resulting in excessive concentration of the absorbing solution and hampering continuous operation. It is therefore necessary to prevent the temperature of the treatment water from being very much lower than the temperature of the absorbing solution. In order to satisfy this requirement, the water vapor pressure difference may be −20 kPa or higher, −15 kPa or higher, −10 kPa or higher, −5 kPa or higher, −3 kPa or higher, −2 kPa or higher or −1 kPa or higher.

If the temperature of the treatment water is very much higher than the temperature of the absorbing solution, on the other hand, water in the treatment water will migrate to the absorbing solution thus diluting the absorbing solution, and impairing the effect of removing the volatile solute. In order to avoid such a situation, the water vapor pressure difference may be 5 kPa or lower, 4 kPa or lower, 3 kPa or lower, 2 kPa or lower, 1 kPa or lower or 0 kPa or lower.

The water vapor pressure difference may be −10 kPa to 1 kPa, for example.

In order to prevent migration of water in the treatment water into the absorbing solution, the temperature of the absorbing solution at the absorbing solution inlet of the membrane contactor is at or above the temperature of the treatment water at the treatment water inlet of the membrane contactor.

For the same reason, the temperature of the absorbing solution at the absorbing solution outlet of the membrane contactor is at or above the temperature of the treatment water at the treatment water outlet of the membrane contactor.

In the method of operating a volatile solute removal device according to the second viewpoint of the invention, preferably the logarithmic mean water vapor pressure difference calculated by the following mathematical formula (19) is −5 kPa to 1 kPa.

Logarithmic mean water vapor pressure difference=[(P_{A1}−P_{B1})−(P_{A2}-P_{B2})]/ln[(P_{A1}−P_{B1})/(P_{A2}-P_{B2})] (19)
P_{A1}: Water vapor pressure of treatment water at treatment water inlet of membrane contactor
P_{A2}: Water vapor pressure of treatment water at treatment water outlet of membrane contactor
P_{B1}: Water vapor pressure of absorbing solution at absorbing solution inlet of membrane contactor
P_{B2}: Water vapor pressure of absorbing solution at absorbing solution outlet of membrane contactor

In the method of operating a volatile solute removal device according to the second viewpoint of the invention, the logarithmic mean water vapor pressure difference calculated by mathematical formula (19) above is preferably −5 kPa or higher so that the water vapor pressure difference is not too low throughout the entire membrane module from the treatment water inlet of the membrane contactor to the treatment water outlet. For this purpose, the logarithmic mean water vapor pressure difference may be −3 kPa or higher, −2 kPa or higher, −1 kPa or higher or 0 kPa or higher.

The logarithmic mean water vapor pressure difference calculated by mathematical formula (19) above is also preferably 1 kPa or lower so that the water vapor pressure difference is not too high throughout the entire membrane module from the treatment water inlet of the membrane contactor to the treatment water outlet. For this purpose, the logarithmic mean water vapor pressure difference may be 0 kPa or lower, −1 kPa or lower or −2 kPa or lower.

In the method of operating a volatile solute removal device according to the second viewpoint of the invention, the amount of volatile solute that can be absorbed per unit volume of the absorbing solution will generally be greater than the amount of volatile solute per unit volume of the treatment water. In this case, the linear velocity of the absorbing solution inside the membrane contactor is slower than the linear velocity of the treatment water inside the membrane contactor, in order to reduce power consumption by the pump used for liquid circulation.

In the method of operating a volatile solute removal device according to the second viewpoint of the invention, the treatment water may be fed to the membrane contactor in one pass, or it may be recirculated.

Feeding the treatment water to the membrane contactor in one pass means that, for example, the treatment water stored in the treatment water tank is fed to the membrane contactor and passed through the membrane contactor once, after which it is removed from the method of operating a volatile solute removal device of the invention, and is not reused for supply to the membrane contactor. Recirculating the treatment water to the membrane contactor means that, for example, the treatment water stored in the treatment water tank is fed to the membrane contactor, passed through the membrane contactor once and returned to the treatment water tank, being mixed with the treatment water in the treatment water tank, after which it is reused for supply to the membrane contactor.

The absorbing solution is recirculated to the membrane contactor.

It will be understood that recirculation of the absorbing solution to the membrane contactor is similar to recirculation of the treatment water.

When water vapor migrates from the treatment water into the absorbing solution during volatile solute removal by the method of the invention, thermal energy as latent heat of the water vapor is lost from the treatment water. The temperature of the treatment water is thus lowered, resulting in lower vapor pressure of the volatile solute. When water migrates into the absorbing solution, the concentration of the absorbing solution decreases, lowering the absorption efficiency.

It is therefore preferred to reduce migration of water vapor from the treatment water to the absorbing solution from the viewpoint of accomplishing more efficient volatile solute removal.

When the water vapor pressure of the absorbing solution is higher than the water vapor pressure of the treatment water, the water vapor migrates from the absorbing solution into the treatment water. In this case the absorbing solution becomes concentrated, potentially hampering continuous operation.

Consequently, migration of water vapor from the treatment water to the absorbing solution and migration of water vapor from the absorbing solution to the treatment water are both preferably limited to within fixed ranges. Specifically, if water vapor flux from the treatment water to the absorbing solution is defined as a positive value, then the water vapor flux is preferably −10 kg/m²·h to 10 kg/m²·h, more preferably −5 kg/m²·h to 5 kg/m²·h and even more preferably −1.5 kg/m²·h to 1.5 kg/m²·h.

The water vapor flux J w is expressed by the following formula (9).

$$\begin{matrix}[ Mathematical Formula 1 ] & \\ {J}_{w} = \frac{{W}_{P}}{A \cdot T} & ( 9 )\end{matrix}$$

{In formula (9), Wp is the mass (kg) of the water evaporated from the treatment water and moving through the hollow fiber membrane, A is the effective area (m²) of the hollow fiber membrane, and T is the operating time (h).}

The distillation unit according to the second viewpoint of the invention may be appropriately selected from among publicly known distillation units.

The type of distillation unit may be a natural circulation type (external heating system or calandria type), forced circulation type, thin-film flow type, thin-film rise type or jacket-coil type, for example.

The distillation may be carried out either at atmospheric pressure or under reduced pressure.

### <Third Viewpoint of the Invention>

The third viewpoint of the invention is a method of operating a volatile solute removal device in order to remove a volatile solute from treatment water comprising both a volatile solute and a non-volatile solute using a membrane contactor, wherein:
in a membrane module having a hollow fiber bundle formed of a plurality of hollow fiber membranes,
the membranes used for the membrane contactor are hollow fiber membranes, with treatment water being flowed to the insides of the hollow fiber membranes to remove the volatile solute,
each hollow fiber membrane consists of hollow fibers,
the Reynolds number of the treatment water flowed to the insides of the hollow fiber membranes is 1,100 to 7,000, and
the linear velocity of the treatment water flowed to the insides of the hollow fiber membranes is 3.5 m/s or lower.

In the method of operating a volatile solute removal device according to the third viewpoint of the invention, when hollow fiber membranes are used in the membrane contactor membrane for volatile solute removal in which treatment water is flowed on the insides of the hollow fiber membranes, the Reynolds number and linear velocity of the treatment water flowed to the insides of the hollow fiber membranes are each set to the aforementioned ranges to inhibit deposition of scales on the membrane surfaces while simultaneously inhibiting pressure loss.

The reason why this effect is exhibited is conjectured to be as follows.

However, the present invention is not to be constrained by this theory.

### <Inhibition of Scale Deposition>

The treatment water for the third viewpoint of the invention will usually contain large amounts of scale components. When the scale component concentration in the treatment water rises above the saturated solubility, scale components are deposited on the surfaces of the hollow fiber membranes.

The ease of deposition of a scale component is determined by the concentration polarization coefficient (CPC) of the scale component, represented by the following formula (1).

$$\begin{matrix}[ Mathematical Formula 2 ] & \\ CPC = \frac{{C}_{m , f}}{{C}_{b , f}} = exp ( {J}_{w} / ρ k ) & ( 1 )\end{matrix}$$

{In formula (1), C_{m,f} is the non-volatile solute concentration (wt %) on the membrane surfaces, C_{b,f} is the non-volatile solute concentration (wt %) of the entire treatment water, J_{w} is the membrane water vapor flux (kg/m²·h), p is the solution density (kg/m³) of the treatment water and k is the mass transfer coefficient (m/s) when the non-volatile solute is diffused throughout the boundary membrane.

Formula (1) suggests that a larger water vapor flux J w of the membrane increases the CPC and facilitates deposition of scales. The mass transfer coefficient k is represented by the following formula (2).

k=D/δ (2)

In formula (2), D is the diffusion coefficient (m²/s) of the non-volatile solute, and δ is the thickness (m) of the boundary layer on membrane surface.

Inserting formula (2) into formula (1), it is understood that a smaller thickness δ of the boundary layer reduces CPC and helps prevent deposition of scales.

The thickness δ of the boundary layer can be calculated by the following formulas (3) to (5).

$$\begin{matrix}[ Mathematical Formula 3 ] & \\ δ = \frac{D}{k} = \frac{{d}_{h}}{Sh} = \frac{d}{Sh} & ( 3 )\end{matrix}$$

$$Sh = \frac{{kd}_{h}}{D} = \frac{kd}{D} = {a}_{1} R {e}^{{a}_{2}} {{Sc}^{{a}_{3}} ( \frac{d}{l} )}^{{a}_{4}} \qquad ( 4 )$$

$${S}_{C} = \frac{μ}{ρ D} \qquad ( 5 )$$

{In formulas (3) to (5), D is the diffusion coefficient (m²/s) of the non-volatile solute, k is the mass transfer coefficient (m/s) when the non-volatile solute is diffused throughout the boundary layer, dₕ is the hydraulic diameter (m), d is the inner diameter (m) of the hollow fiber membrane, Sh is the Sherwood number (dimensionless number), Re is Reynolds number, Sc is the Schmidt number, 1 is the flow channel length (m), a₁, a₂, a₃ and a₄ are experimentally determined constants, and μ is the viscosity (Pas) of the treatment water.}

According to the invention, the hydraulic diameter dₕ (m) is equal to the inner diameter d (m) of the hollow fiber membrane.

From formulas (3) to (5) it is understood that the thickness δ of the boundary layer is inversely proportional to Reynolds number Re. Thus, it will be understood that a larger Reynolds number Re results in a smaller boundary layer thickness δ and a smaller CPC, and helps to prevent deposition of scales.

According to the invention, the Reynolds number Re is 1,100 or greater, so that even when the water vapor pressure difference is large resulting in high large water vapor flux J w of the membrane, the CPC is low and deposition of scales is inhibited to allow stable volatile solute removal to be carried out.

It is to be noted that the aforementioned mathematical formulas take into account the contribution of the hydraulic diameter dₕ, which is equivalent to the inner diameter of the hollow fiber membrane, and the boundary layer thickness δ, and that the Reynolds number Re used for the invention is therefore appropriate regardless of the size of the hollow fiber membrane used.

From this viewpoint, the Reynolds number Re used for the invention may be 1,100 or greater, and is preferably 1,500 or greater, or even 2,000 or greater or 2,300 or greater. The advantage of an excessively large Reynolds number Re is minimal, however, and setting the Reynolds number to be unreasonably large may be problematic for the efficiency and stability of volatile solute removal. From this viewpoint, the Reynolds number Re for the invention is preferably 7,000 or lower, more preferably 6,000 or lower, even more preferably 5,000 or lower, and especially 4,000 or lower, 3,000 or lower, 2,300 or lower or 2,000 or lower.

The pressure loss ΔP (Pa) of the treatment water is calculated by the following formula (6).

$$\begin{matrix}[ Mathematical Formula 4 ] & \\ Δ P = \frac{f ρ {v}^{2} L}{2 d} & ( 6 )\end{matrix}$$

{In formula (6), f is the friction coefficient, ρ is the solution density (kg/m³) of the treatment water, v is the linear velocity of the treatment water (m/s), L is the length (m) of the hollow fiber membrane and d is the inner diameter (m) of the hollow fiber membrane.

In the volatile solute removal device according to the third viewpoint of the invention, the membrane contactor membrane is a hollow fiber membrane and the hollow fiber membrane is in the form of a membrane contactor membrane module. When a portion of the hollow fiber membrane is embedded in an adhesive resin layer, the length of the hollow fiber membrane L in formula (6) also includes the section embedded in the adhesive resin layer.

In regard to the friction coefficient f, the friction coefficient F₁ for a laminar flow or the friction coefficient Ft for a turbulent flow will differ, and therefore the pressure loss ΔP₁ (Pa) of the treatment water for a laminar flow and the pressure loss ΔPₜ (Pa) of the treatment water for a turbulent flow are represented by the following formulas (7) and (8), respectively.

$$\begin{matrix}[ Mathematical Formula 5 ] & \\ Δ {P}_{l} = \frac{32 μ Lv}{{d}^{2}} & ( 7 )\end{matrix}$$

$$Δ {P}_{t} = 0.158 \frac{ρ {v}^{2} L}{d} {( \frac{μ}{ρ v d} )}^{\frac{1}{4}} \qquad ( 8 )$$

{The reference symbols in formulas (7) and (8) are the same as the symbols in the preceding formulas.}

Based on formulas (7) and (8) it is understood that a smaller linear velocity of the treatment water v results in less pressure loss of the treatment water, regardless of whether the flow is a laminar flow or turbulent flow.

According to the invention, the linear velocity of the treatment water v is set to 3.5 m/s or lower so that the pressure loss is small enough to allow high efficiency volatile solute removal to be carried out.

According to general fluid mechanics, the flow is said to be a laminar flow if the Reynolds number Re is about 2,300 or lower and a turbulent flow if the Reynolds number Re is greater than about 2,300, with different constructed models for laminar flow and turbulent flow.

According to the invention, however, the linear velocity of the treatment water v is set to within the range specified for the invention, thus allowing the pressure loss of treatment water to be controlled regardless of whether the flow is a laminar flow or turbulent flow.

Thus, the linear velocity of the treatment water v according to the third viewpoint of the invention is 3.5 m/s or lower, preferably 3.0 m/s or lower, more preferably 2.5 m/s or lower, even more preferably 2.0 m/s or lower, and especially 1.6 m/s or lower, 1.0 m/s or lower, or 0.8 m/s or lower.

From the viewpoint of increasing the efficiency of volatile solute removal, on the other hand, the linear velocity of the treatment water v is preferably 0.4 m/s or greater, more preferably m/s or greater, even more preferably 0.7 m/s or greater and especially 1.0 m/s or greater.

Pressure loss is inhibited by the method according to the third viewpoint of the invention. As a result, the pressure difference between the insides and outsides of the hollow fiber membranes can be lowered and passage of treatment water directly through the hollow fiber membrane walls is inhibited.

By the method according to the third viewpoint of the invention it is possible to limit the pressure difference between hollow fiber membranes at the treatment water inlet to 450 kPa or lower, or to 390 kPa or lower or 150 kPa or lower.

When volatile solute removal is carried out by the method according to the third viewpoint of the invention, the water vapor flux migrating from the treatment liquid through the hollow fiber membranes is 10 kg/m²·h or lower, more preferably 8 kg/m²·h or lower and even more preferably 4 kg/m²·h or lower from the viewpoint of inhibiting scale deposition.

The water vapor flux J_{w} is represented by the following formula (9) as explained above.

$$\begin{matrix}[ Mathematical Formula 6 ] & \\ {J}_{w} = \frac{{W}_{P}}{A \cdot T} & ( 9 )\end{matrix}$$

{In formula (9), Wp is the mass (kg) of the water evaporated from the treatment water and moving through the hollow fiber membrane, A is the effective area (m²) of the hollow fiber membrane, and T is the operating time (h).}

### <Treatment Water According to Second and Third Viewpoints of the Invention>

The method according to the second and third viewpoints of the invention is a method of removing a volatile solute from treatment water.

The treatment water is a liquid mixture containing a volatile solute, a non-volatile solute and a solvent. The treatment water will typically be a solution but may also be an emulsion or suspension, so long as it is liquid.

<Non-volatile solute>

A non-volatile solute in treatment water is a substance that has essentially no vapor pressure and does not dissolve at the operating temperature of the volatile solute removal device.

Typical examples of non-volatile solutes include pharmaceutical raw materials, chemicals and inorganic salts.

Examples of pharmaceutical raw materials and chemicals include amino acids, peptides, proteins, sugars, vaccines, nucleic acids, antibiotics, antibody-drug conjugates (ADC), surfactants and vitamins.

Amino acids are compounds having one amino acid backbone and comprising a carboxyl group and an amino group, and a portion linking them. For the purpose of the invention, amino acids include essential amino acids, non-essential amino acids and non-natural amino acids.

Examples of essential amino acids include tryptophan, lysine, methionine, phenylalanine, threonine, valine, leucine and isoleucine. Examples of non-essential amino acids include arginine, glycine, alanine, serine, tyrosine, cysteine, asparagine, glutamine, proline, aspartic acid and glutamic acid.

A non-natural amino acid is any compound that has an amino acid backbone in the molecule and that is artificial and not found in nature. However, a non-natural amino acid used as a pharmaceutical raw material may be obtained by bonding a desired labeling compound to an amino acid backbone. Examples of labeling compounds include pigments, fluorescent substances, luminescent substances, enzyme substrates, coenzymes, antigenic substances and protein binding substances.

Examples of preferred non-natural amino acids as pharmaceutical raw materials include labeled amino acids and functionalized amino acids. Labeled amino acids are non-natural amino acids comprising an amino acid backbone and a labeling compound bonded together, specific examples of which include amino acids having an amino acid backbone containing an aromatic ring on a side chain, bonded to a labeling compound. Examples of functionalized amino acids include photoresponsive amino acids, photo-switchable amino acids, fluorogenic probe amino acids and fluorescent-labeled amino acids.

Peptides are compounds having amino acid residues of at least 2 and less than 70 residues bonded together, either in a linear or cyclic fashion. Examples of peptides include L-alanyl-L-glutamine, β-alanyl-L-histidine cyclosporin and glutathione.

Proteins are generally amino acid residue-bonded compounds having longer chain lengths than peptides. Proteins for the purpose of the invention are preferably those applied in protein preparations.

Examples of protein preparations include interferon-α, interferon β, interleukin-1 to 12, growth hormones, erythropoietin, insulin, granulocyte colony-stimulating factor (G-CSF), tissue plasminogen activator (TPA), sodium diuretic peptide, blood clotting factor VIII, somatomedin, glucagon, growth hormone releasing factor, serum albumin and calcitonin.

Examples of sugars include monosaccharides, disaccharides, sugar chains (excluding disaccharides) and sugar chain derivatives.

Examples of monosaccharides include glucose, fructose, galactose, mannose, ribose and deoxyribose. Examples of disaccharides include maltose, sucrose and lactose.

For the purpose of the invention, “sugar chain” excludes the concept of disaccharides, and examples are glucose, galactose, mannose, fucose, xylose, glucuronic acid and iduronic acid. Examples of sugar chain derivatives include N-acetylglucosamine, N-acetylgalactosamine, N-acetylneuraminic acid.

Examples of vaccines include hepatitis A vaccine, hepatitis B vaccine, hepatitis C vaccine and COVID-19 vaccine,
examples of nucleic acids include oligonucleotides, RNA, aptamers and decoys, and
examples of antibiotics include streptomycin and vancomycin.

Examples of vitamins include the vitamin A group, vitamin B group and vitamin C group, including their derivatives and salts. The vitamin B group includes vitamin B6 and vitamin B12, for example.

Examples of surfactants include anionic surfactants such as polysaccharides, phospholipids, peptides and sodium laurylsulfate; cationic surfactants such as benzalkonium chloride; amphoteric surfactants; and nonionic surfactants such as polyethylene glycol.

Examples of inorganic salts include sodium chloride and magnesium chloride.

The number-average molecular weight of the non-volatile solute may be 75,000 or lower, preferably 50,000 or lower, more preferably 10,000 or lower and most preferably 6,000 or lower. An excessively large molecular weight of the non-volatile solute will result in excessively high viscosity of the treatment water and increased pressure loss in the treatment water flow channel, and will tend to cause deposition of the solute due to overconcentration on the surfaces of the hollow fiber membranes.

### <Volatile Solute>

A volatile solute in treatment water is a substance that exhibits significant vapor pressure and does not dissolve at the operating temperature of the volatile solute removal device.

Examples of volatile solutes include volatile acids, volatile bases and volatile polar compounds (excluding acids and bases).

Examples of volatile acids include hydrochloric acid, carbonic acid and acetic acid.

Ammonia is an example of a volatile base.

Examples of volatile polar compounds (excluding acids and bases) include alcohols and acetonitrile. Examples of alcohols include methanol, ethanol, n-propanol and i-propanol.

### (Solvent)

The solvent of the treatment water may include water. Water is preferably included in the solvent of the treatment water because it has high surface energy with respect to the surface of hydrophobic hollow fiber membranes, and thus allows efficient separation of membrane surface liquids from vapor of the volatile solute.

The solvent of the treatment water may be water or a mixed solvent comprising water and a water-soluble organic solvent, but will typically be water.

### <Treatment Water Aspects>

Examples of treatment water to be applied according to the second and third viewpoints of the invention include solutions containing bulk pharmaceuticals or chemicals; chemical process water; denitrification equipment waste water; foods; seawater; and accessory water discharged from gas or oil fields.

When the method according to the second and third viewpoints of the invention is applied for removal of a volatile solute from treatment water, it is possible to stably obtain treated water that essentially maintains the composition of the non-volatile solutes in the original treatment water. The method of the invention can therefore be applied not only for waste water treatment but also in raw material purification steps during the intermediate stages of pharmaceutical and chemical production.

Applying the method according to the second and third viewpoints of the invention for water production can also stably yield purified water from which volatile solutes in treatment water have been essentially removed. The method of the invention is therefore also useful for production of drinking water and domestic water in dry regions.

According to the second and third viewpoints of the invention, the temperature of the treatment water during removal of a volatile solute from treatment water may be 0° C. to 100° C., for example.

When an absorbing solution is flowed in the space on the outsides of the hollow fiber membranes of a membrane contactor for removal of a volatile solute, the temperature of the treatment water does not need to be very high. The temperature of the treatment water in such cases may be, for example, 0° C. or higher, 10° C. or higher, 20° C. or higher or 30° C. or higher, and 60° C. or lower, 50° C. or lower or 40° C. or lower.

An alkali may also be added to the treatment water to adjust the pH of the treatment water to at least 10 or higher before supply to the method of the invention.

### <Absorbing Solution>

The absorbing solution according to the second and third viewpoints of the invention is a solution having a property of taking up a volatile solute that has been flowed on one side of the membrane contactor membrane in the volatile solute removal device so that it contacts with the treatment water across the membrane contactor membrane, and thus volatilizes from the treatment water, passing through the membrane contactor membrane and migrating to the opposite side of the membrane contactor membrane.

The absorbing solution may be, for example, a good solvent for the volatile solute, or a solution that includes a substance that can react with the volatile solute.

Specifically, when the volatile solute is a volatile basic compound (such as ammonia), for example, the absorbing solution may be an aqueous solution of an acid. In this case the volatile solute-containing absorbing solution will contain a salt of the basic compound and the acid.

When the volatile basic compound is ammonia, in particular, the absorbing solution may contain an acid and the volatile solute-containing absorbing solution may contain a salt of ammonia and the acid.

When the volatile solute contains a volatile acidic compound (such as hydrochloric acid, carbonic acid or acetic acid), the absorbing solution may be a base aqueous solution.

When the volatile solute is a volatile polar compound (such as an alcohol or acetonitrile), the absorbing solution may be water.

The absorbing solution may be flowed on the outside of the hollow fiber membrane at any linear velocity. The linear velocity of the absorbing solution may be 0.1 m/s to 5.0 m/s, for example.

The absorbing solution may be in cocurrent flow in the same direction as the direction of flow of the treatment water, or it may be in countercurrent flow, flowing in the direction opposite from the direction of flow of the treatment water.

The temperature of the absorbing solution during volatile solute removal may be any temperature. The temperature of the absorbing solution may be 0° C. to 100° C., for example, and is preferably 15° C. to 70° C. and more preferably 20° C. to 60° C.

### <Pressure Reduction>

According to the second and third viewpoints of the invention, when the volatile solute removal device is operated with the outside of the hollow fiber membranes in a reduced pressure state, the pressure on the outsides of the hollow fiber membranes may be lower than the vapor pressure of the volatile solute in the treatment water flowing on the insides of the hollow fiber membranes (treatment water side). The pressure on the outsides of the hollow fiber membranes may be 90% or lower, and is preferably 80% or lower, 70% or lower, 60% or lower or 50% or lower, with respect to the vapor pressure of the volatile solute.

Specifically, when the pressure of the insides of the hollow fiber membranes is 1 atm, for example, the pressure on the outsides of the hollow fiber membranes may be 0.9 atm or lower, and is preferably 0.8 atm or lower, 0.7 atm or lower, 0.6 atm or lower or 0.5 atm or lower.

### <Electrodialysis Unit>

When the method according to the second viewpoint of the invention is electrodialysis, the electrodialysis unit used may be appropriately selected from among the units described above for the electrodialysis unit according to the first viewpoint.

### EXAMPLES

Examples and Reference Examples will now be described as concrete illustrations of the construction and effect of the invention. However, the invention is not limited in any way by these Examples and Reference Examples.

### (Fabrication of Membrane Module for Membrane Distillation)

The hollow fiber membrane modules used in Examples 1 and 2 were fabricated in the following manner using PVDF (polyvinylidene fluoride) hollow fiber membranes.

A fiber bundle was prepared by bundling 500 hollow fiber membranes cut out to lengths of 45 cm, and was inserted into a housing. A thermosetting epoxy resin was used as the adhesive resin and the membrane bundle was adhesively anchored inside the housing, forming an adhesive resin layer by centrifugal bonding.

This procedure was carried out to fabricate a hollow fiber membrane module having a 30 cm porous length for each hollow fiber membrane (the length of the section not embedded in the adhesive resin layer), and a total area of 0.32 m² for the inner surfaces of the hollow fiber membranes.
The details of the hollow fibers are as follows.
Inner diameter: 0.68 mm
Outer diameter: 1.25 mm
Membrane thickness: 0.28 mm
Average pore diameter: 0.21 μm
Maximum pore diameter: 0.29 μm
Porosity: 72%
Water contact angle: 103° (hollow fiber membrane outer surface)

The housing has an ammonia-containing waste water inlet and an ammonia-containing waste water outlet at the respective ends of the cylindrical form. The construction is such that ammonia-containing waste water enters into the membrane module for membrane distillation through the ammonia-containing waste water inlet and passes through the hollow sections of the hollow fiber membranes, and is then discharged outside of the membrane module for membrane distillation through the ammonia-containing waste water outlet.

The housing has an ammonia extraction outlet on the side wall of the cylindrical form, and it may be connected to a reduced-pressure chamber provided with a cooling unit into which cooling water flowes through the ammonia extraction outlet. With this construction, it is possible to lower the pressure in the space on the outside of the hollow fiber membranes of the membrane module for membrane distillation, and to extract water vapor and ammonia vapor that have evaporated from the ammonia-containing waste water by membrane distillation, through the pressure reduction chamber.

The fluorine resin-based water repellent “FS1610” by Fluorotechnology Co. (polymer concentration: 1.0 mass %) was injected into the hollow sections of the hollow fibers through the ammonia-containing solution inlet of the hollow fiber membrane module, using a syringe inserted into the hollow fiber membrane module. During the injection procedure, the entire surface insides of the hollow fiber membranes were wetted with the water repellent until the water repellent seeped out from the outsides of the hollow fiber membranes. The excess water repellent was then removed from the hollow fiber membrane module, after which dry air at 25° C. was streamed through the hollow sections of the hollow fiber membranes for overnight drying, to fabricate a membrane module for membrane distillation with the entirety of the hollow fiber membranes hydrophobized.

(Distillation of Ammonia from Ammonia-Containing Waste Water Using Membrane Distillation)

The membrane module for membrane distillation was connected to a reduced-pressure chamber provided with a cooling unit through which cooling water flowed through an ammonia extraction outlet.

A 4 mass % sodium hydroxide aqueous solution was added to 30 L of ammonia-containing waste water (1 mass % containing ammonia), for adjustment to pH 12. The pH-adjusted ammonia-containing waste water was flowed through the insides of the hollow fiber membranes of the membrane module for membrane distillation using a pump at a flow rate of 5 L/min. The temperature of the ammonia-containing waste water during this time was regulated using a temperature regulator to keep the ammonia-containing waste water inlet at 50° C.

Cooling water was flowed through the cooling unit of the pressure reduction chamber using a pump at a flow rate of 10 L/min, adjusting the temperature of the cooling unit to 5° C.

The pressure in the space outside of the hollow fibers of the membrane module for membrane distillation was set to 0.25 kPa.

After membrane distillation operation for 3 hours, 20 kg of ammonia water with an ammonia concentration of 1.35 mass % and 10 kg of distillation residue with an ammonia concentration of 1,000 ppm were obtained. The ammonia contents in the ammonia water and distillation residue were 96.7% and 3.3%, respectively, with respect to the ammonia concentration in the ammonia-containing waste water.

### (Fabrication of Membrane Contactor Membrane Module)

A membrane contactor membrane module with the structure shown in FIG. 2 was fabricated using the same type of PVDF hollow fiber membranes used in the membrane module for membrane distillation.

A fiber bundle was prepared by bundling 70 hollow fiber membranes cut out to lengths of cm, and was inserted into a housing. A thermosetting epoxy resin was used as the adhesive resin and the membrane bundle was adhesively anchored inside the housing, forming an adhesive resin layer by centrifugal bonding.

This procedure was carried out to fabricate a hollow fiber membrane module having a 24 cm porous length for each hollow fiber membrane (the length of the section not embedded in the adhesive resin layer), and a total area of 360 cm² for the inner surfaces of the hollow fiber membranes.

### (Recovery of Ammonia by Acid Using Hydrophobic Porous Membrane)

The distillation residue obtained by the aforementioned membrane distillation step was circulated through the insides of the hollow fiber membranes of the membrane contactor membrane module using a pump at a flow rate of 300 mL/min. A 500 mL portion of a 7.5 mass % sulfuric acid aqueous solution as an acid solution was flowed into the space on the outsides of the hollow fiber membranes, in a cocurrent flow with the distillation residue.

The circulating operation was carried out for 6 hours under the conditions described above.

During this time, the temperature of the distillation residue and the sulfuric acid aqueous solution was regulated using a temperature regulator so that a temperature of 50° C. was maintained at both the ammonia-containing solution inlet and acid solution inlet of the membrane contactor membrane module.

The ammonia concentration in the distillation residue after completion of operation was 50 ppm. Of the sulfuric acid in the acid solution after completion of operation, 95% had reacted with the membrane-permeated ammonia to become ammonium sulfate, resulting in a combined sulfuric acid and ammonium sulfate concentration of 10 mass % in the acid solution. The acid solution after completion of operation will hereunder be referred to as “membrane contactor treatment liquid”.

### Example 1

In Example 1, electrodialysis was carried out using an electrodialysis unit by the two-chamber method.

Electrodialysis of 500 mL of the membrane contactor treatment liquid obtained from the membrane contactor was carried out using a two-chamber electrodialysis unit (ACILYZER EX3B by Astom Corp.) comprising a bipolar membrane and an anion exchange membrane, removing the sulfuric acid from the ammonia recovery solution.

A NEOSEPTA BP-1E (Astom Corp.) was used as the bipolar membrane, and a NEOSEPTA AHA (Astom Corp.) was used as the anion exchange membrane. The construction of the membrane was (cathode chamber) BP-A-BP-A-BP-A-BP-A-BP-A-BP-A-BP-A-BP-A-BP-A-BP-A-BP (anode chamber), with an effective membrane area of 550 cm². Here, “BP” stands for bipolar membrane, and “A” stands for anion exchange membrane.

The electrode solution was 500 mL of a 4 mass % sodium hydroxide aqueous solution, and the acid recovery liquid was 500 mL of purified water.

Electrodialysis was carried out under conditions with a voltage of 14 V and a temperature of During a treatment time of 33 minutes, the sulfate ion yield recovered in the acid recovery liquid was 92%, against 100% as the sulfuric acid content of the membrane contactor treatment liquid, the accumulated current value was 2.38 Ah, and the electrical energy was 59.5 Wh.

The ammonia concentration in the distillation residue after completion of operation was 3 mass %, and the ammonium sulfate concentration was 1.1 mass % (0.8 mass % as sulfuric acid).

Next, using the distillation residue (ammonia-concentrated solution) after electrodialysis treatment, ammonia was recovered into the condensed water after distillation by the same procedure as “(Distillation of ammonia from ammonia-containing waste water using membrane distillation)” above.

By the series of steps described above, the ammonia recovered into the condensed water after the final distillation was 96.7% of the ammonia present in the membrane contactor treatment liquid, and the recovered ammonia purity (P_{NH3}) calculated by the following formula (22) was >99.0%.

P_{NH3}(%)=(C_{NH3}/C_{All})×100 (22)

{In the formula, C_{NH3} is the ammonia concentration (mass %) in the condensed water and C_{All} is the total solute concentration (mass %) in the condensed water.}

C_{NH3} and C_{All} were analyzed using a gas chromatograph (GC-4000plus) by GL Sciences Inc.

### Example 2

In Example 2, electrodialysis was carried out using an electrodialysis unit by the three-chamber method.

Electrodialysis of 500 mL of the membrane contactor treatment liquid was carried out using a three-chamber electrodialysis unit (ACILYZER EX3B by Astom Corp.) comprising a bipolar membrane, an anion exchange membrane and a cation exchange membrane, removing the ammonia and sulfuric acid from the membrane contactor treatment liquid.

A NEOSEPTA BP-1E (Astom Corp.) was used as the bipolar membrane, a NEOSEPTA AHA (Astom Corp.) was used as the anion exchange membrane, and a NEOSEPTA BMX (Astom Corp.) was used as the cation exchange membrane. The construction of the membrane was (cathode chamber) BP-A-C-BP-A-C-BP-A-C-BP-A-C-BP-A-C-BP-A-C-BP-A-C-BP-A-C-BP-A-C-BP-A-C-BP (anode chamber), with an effective membrane area of 550 cm². Here, “BP” stands for bipolar membrane, “A” stands for anion exchange membrane, and “C” stands for cation exchange membrane.

The electrode solution was 500 mL of a 4 mass % sodium hydroxide aqueous solution, the acid recovery liquid was 500 mL of purified water, and the ammonia recovery solution was 500 mL of purified water. Electrodialysis was carried out under conditions with a voltage of 25 V and a temperature of 25° C.

During a treatment time of 109 minutes, the ammonia (ammonium ion) yield recovered in the ammonia recovery solution (ammonia-concentrated solution) after electrodialysis was 67.0%, the sulfuric acid (sulfate ion) yield recovered in the acid recovery liquid was 90.0%, against 100% as the sulfuric acid content of the membrane contactor treatment liquid, the accumulated current value was 3.69 Ah, and the electrical energy was 76.5 Wh.

The ammonia purity was 74.0%, as calculated by formula (22) above with C_{NH3} as the ammonia concentration (mass %) in the ammonia-concentrated solution and C_{All} as the total solute concentration (mass %) in the ammonia-concentrated solution.

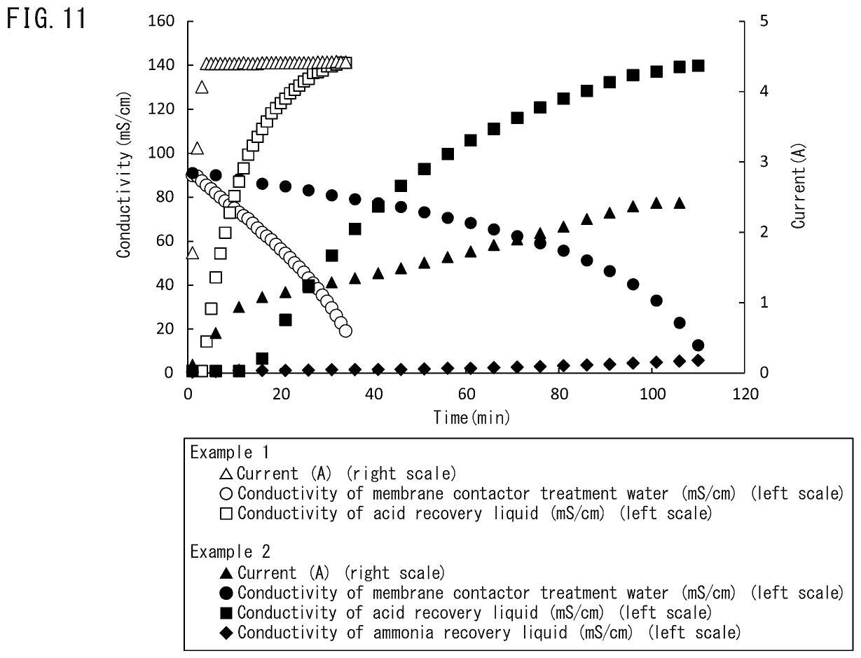

The results are summarized in Table 1-1 below. The state of operation used for electrodialysis is shown in FIG. 11.

TABLE 1-1

| | | Electrodialysis | | | | | | | | |
|---|---|---|---|---|---|---|---|---|---|---|
| | | | | Accumulated | | | | | | |
| | | | Operating | current | Electrical | SO₄²⁻ | NH₄⁺ | | Recovered ammonia | |
| | | | time | value | energy | yield | yield | | Yield | Purity |
| | System configuration | Type | (min) | (Ah) | (Wh) | (%) | (%) | Distillation | (%) | (%) |
| Example 1 | Two-chamber electrodialysis | Two-chamber | 33 | 2.38 | 59.5 | 92.0 | — | Membrane | 96.7 | >99.0 |
| | → distillation | | | | | | | distillation | | |
| Example 2 | Three-chamber electrodialysis | Three-chamber | 109 | 3.69 | 76.5 | 90. | 67.0 | — | 67.0 | 74.0 |
| | → distillation | | | | | | | | | |

The physical properties of the membrane contactor membranes in Reference Examples 1-1 to 1-11 and 2-1 to 2-7 and Comparative Reference Examples 1-1 to 1-3 and 2-1 to 2-5 were measured by the following methods.

### (1) Flat Sheet Membrane Thickness, and Hollow Fiber Membrane Outer Diameter, Inner Diameter and Membrane Thickness

The flat sheet membrane thickness was determined using a thickness gauge.

The hollow fiber membrane outer diameter, inner diameter and membrane thickness were determined by microscopic observation. The specific method was as follows.

The hollow fiber membrane was thinly cut with a razor in the direction perpendicular to the lengthwise direction and a microscope image of the cross-section was taken. The obtained microscope image was measured to determine the outer diameter and inner diameter of the hollow fiber membrane. The membrane thickness of the hollow fiber membrane was determined by calculation from the outer diameter and inner diameter.

### (2) Hollow Fiber Membrane Average Pore Diameter

The average pore diameter of the hollow fiber membrane was measured by the method of measuring average pore diameter described in ASTM:F316-86 (“half-dry method”).

The hollow fiber membrane cut to a length of 10 cm was used as the sample for measurement under standard measuring conditions of 25° C. with a pressurization rate of 0.01 atm/sec, using ethanol as the liquid.

The average pore diameter was calculated by the following formula (10):

Average pore diameter[μm]=2,860×(s/p) (10)

{In formula (10), s is the surface tension (units: dyne/cm) of the liquid used, and p is the half-dry air pressure (units: Pa).}

The value used for the surface tension s of ethanol at 25° C. was 21.97 dyne/cm.

### (3) Membrane Maximum Pore Diameter

The membrane maximum pore diameter was measured by the bubble point method, using ethanol as the immersion liquid.

The maximum pore diameter of each hollow fiber membrane was measured by the following method.

The hollow fiber membrane cut to a length of 8 cm was closed off at one end, and a nitrogen gas supply line was connected to the other end via a pressure gauge. After supplying nitrogen gas in this state to exchange the hollow fiber membrane interior with nitrogen, the hollow fiber membrane was immersed in ethanol with the line interior in a slightly pressurized state with nitrogen. Nitrogen pressurization is carried out to avoid reverse flow of ethanol in the line.

With the hollow fiber membrane immersed in ethanol, the nitrogen gas pressure was slowly increased and the pressure P (kg/cm²) at which nitrogen gas bubbles began to stably emerge from the hollow fiber membrane was recorded. The value of P was plugged into the following formula (21):

d=C1γ/P (21)

{where d is the maximum pore diameter of the hollow fibers, C1 is a constant, γ is the surface tension of the immersion liquid and P is the pressure}, to calculate the maximum pore diameter d of the hollow fiber membrane. The value of C1γ was 0.632 (kg/cm), with ethanol as the immersion liquid.

For the flat sheet membrane maximum pore diameter, measurement was by the same method as a hollow fiber membrane, except that the membrane punched out to 50 mmφ was set in a housing and nitrogen gas was supplied into the housing.

### (4) Porosity of Membrane Contactor Membrane

The porosity of the membrane contactor membrane (the average porosity for the entire membrane) was calculated from the membrane mass and the density (true density) of the material forming the membrane.

For example, when the membrane contactor membrane was a hollow fiber membrane, the hollow fibers were cut to a fixed length, their mass was measured, and the porosity of the hollow fibers was calculated by the following formula (12):

$$Porosity [ \% ] = ( 1 - \frac{Hollow fiber membrane mass ( g )}{d [ g / {cm}^{3} ] \times \{ {π ( \frac{outer diameter [ cm ]}{2} )}^{2} - {π ( \frac{inner diameter [ cm ]}{2} )}^{2} \} \times length [ cm ]} ] \times 100 \qquad ( 12 )$$

{where d is the true density of the starting polymer for the hollow fiber membrane, and π is the circular constant}.

### (5) [Water Contact Angle of Hollow Fiber Membrane]

The water contact angle of the membrane contactor membrane was measured by the droplet method according to JIS R 3257.

The contact angle was determined by dropping 2 μL of purified water as a droplet onto one surface of a membrane sample (the outer surface in the case of a hollow fiber membrane), in an environment of 23° C., 50% relative humidity, and calculating the angle formed between the droplet and the membrane surface by image analysis. The measurement was performed 5 times and the number-average value was used as the water contact angle.

### Reference Example 1-1

### (1) Fabrication of Hollow Fiber Membrane Module

A PVDF hollow fiber membrane was used to fabricate a hollow fiber membrane module having the structure shown in FIG. 2.

A fiber bundle was prepared by bundling 70 hollow fiber membranes cut out to lengths of 15 cm, and was inserted into a housing. A thermosetting epoxy resin was used as the adhesive resin and the membrane bundle was adhesively anchored inside the housing, forming an adhesive resin layer by centrifugal bonding.

This procedure was carried out to fabricate a hollow fiber membrane module having a 8 cm porous length for each hollow fiber membrane (the length of the section not embedded in the adhesive resin layer), and a total area of 120 cm² for the inner surfaces of the hollow fiber membranes.
Inner diameter: 0.68 mm
Outer diameter: 1.25 mm
Membrane thickness: 0.28 mm
Average pore diameter: 0.21 μm
Maximum pore diameter: 0.29 μm
Porosity: 72%
Water contact angle: 103° (hollow fiber membrane outer surface)
   (2) Adhesion of Hydrophobized Polymer onto Hollow Fiber Membrane (Fabrication of Membrane Module for Membrane Distillation)

The fluorine resin-based water repellent “FS1610” by Fluorotechnology Co. (polymer concentration: 1.0 mass %) was injected by a syringe into the hollow sections of the hollow fibers through the treatment water inlet of the hollow fiber membrane module. During the injection procedure, the entire surface insides of the hollow fiber membranes were wetted with the water repellent until the water repellent seeped out from the outsides of the hollow fiber membranes. The excess water repellent was then removed from the hollow fiber membrane module, after which dry air at 25° C. was streamed through the hollow sections of the hollow fiber membranes for overnight drying, to fabricate a membrane contactor membrane module with the entirety of the hollow fiber membranes hydrophobized (membrane contactor membrane module (100)).

### (3) Volatile Solute Removal Operation

The obtained membrane contactor membrane module (100) was incorporated into the volatile solute removal device (1001) shown in FIG. 4, and volatile solute removal was carried out.

The volatile solute-containing treatment water and absorbing solution used had the following compositions.
Treatment water:
Solvent: water Non-volatile solute: 1,000 ppm sodium chloride Volatile solute: 300 ppm ammonia Liquid volume: 1,000 g

Absorbing solution:
Composition: 10 mass % concentration sulfuric acid aqueous solution
Liquid volume: 1,000 g

After filling the treatment water into the treatment water tank (500), a 10 mol/L concentration sodium hydroxide aqueous solution was added dropwise for adjustment to pH 10 or higher.

The treatment water was circulated through the insides of the hollow fiber membranes in the membrane contactor membrane module (100), using a treatment water pump (P1) at a flow rate of 300 ml/min. The temperature of the treatment water during this time was regulated using a temperature regulator to maintain a temperature of 50° C. at the treatment water inlet of the membrane contactor membrane module (100).

Separately, the absorbing solution was circulated on the outsides of the hollow fiber membranes in the membrane contactor membrane module (100), using an absorbing solution supply pump (P2) at a flow rate of 300 mL/min. The temperature of the absorbing solution during this time was regulated using a temperature regulator to maintain a temperature of 42° C. at the absorbing solution inlet of the membrane contactor membrane module (100).

The treatment water and absorbing solution were flowed through the membrane contactor membrane module (100) in a cocurrent flow, as shown in FIG. 4.

The temperature of the treatment water at the treatment water inlet, the temperature of the absorbing solution at the absorbing solution inlet, the water vapor pressure difference and the logarithmic mean water vapor pressure difference were as shown in Tables 2-1 to 2-3.

Volatile solute removal operation was carried out for 8 hours under the conditions described above.

After the operation, the volatile solute concentration in the treatment water was 20 ppm and the absorbing solution mass was 1,242 g, indicating that the volatile solute had been adequately removed while limiting increase in the absorbing solution.

### Reference Examples 1-2 to 1-7 and Comparative Reference Examples 1-2 and 1-3

Volatile solute removal operation was carried out in the same manner as Reference Example 1-1, except that the compositions of the treatment water and absorbing solution and the operating conditions for volatile solute removal were as listed in Tables 2-1 to 2-3.

In Reference Example 1-4, the membrane contactor membrane module used was a flat sheet membrane module with a membrane area of 60 cm², obtained by using a PTFE flat sheet membrane as the membrane contactor, set on a flat sheet membrane test cell (“C10-T” by Nitto Denko Corp.).

In Comparative Reference Example 1-2, the water in the treatment water migrated into the absorbing solution, lowering the acid concentration of the absorbing solution and lowering the ammonia removal efficiency. In Comparative Reference Example 1-3, the water in the absorbing solution migrated into the treatment water, reducing the absorbing solution volume and interfering with continued operation, and therefore the operation was halted.

### Reference Example 1-8

A 10 L portion of treatment water with the same composition as Reference Example 1-1 was prepared.

The treatment water was flowed by one pass to the insides of the hollow fiber membranes in the membrane contactor membrane module (100), using a treatment water supply pump (P1) at a flow rate of 30 mL/min.

Volatile solute removal operation was carried out in the same manner as Reference Example 1-1, except that the absorbing solution was circulated on the outsides of the hollow fiber membranes at a temperature of 55° C. at the absorbing solution inlet of the membrane contactor membrane module (100) and a flow rate of 30 mL/min.

The results are shown in Table 2-3.

### Reference Example 1-9

Volatile solute removal operation was carried out in the same manner as Reference Example 1-7, except that a sodium hydroxide aqueous solution was not added to the treatment water.

The results are shown in Table 2-3.

### Reference Example 1-10

A volatile solute removal device was operated by the same method as Reference Example 1-7, except that the same membrane contactor membrane module (100) as in Reference Example 1-1 was incorporated into the volatile solute removal device (1002) shown in FIG. 5, and the volatile solute removal was carried out while performing electrodialysis for recovery of the ammonia absorbed into the absorbing solution.

The electrodialysis was carried out using a two-chamber electrodialysis unit (ACILYZER EX3B by Astom Corp.) comprising a bipolar membrane and an anion exchange membrane, with the following electrodialysis conditions.
Electrode solution: 500 mL of 4 mass % sodium hydroxide aqueous solution
Acid recovery liquid: 500 mL of purified water
Bipolar membrane (BP): NEOSEPTA BP-1E by Astom Corp.
Anion exchange membrane (A): NEOSEPTA AHA by Astom Corp.
Membrane structure: (cathode chamber) BP-A-BP-A-BP-A-BP-A-BP-A-BP-A-BP-A-BP-A-BP-A-BP-A-BP (anode chamber)
Effective membrane area: 550 cm²
Voltage: 14 V
Temperature: 25° C.
The results are shown in Table 2-3.

### Comparative Reference Example 1-1

Volatile solute removal operation was carried out by the same method as Reference Example 1-1, except that the absorbing solution was not circulated on the outsides of the hollow fiber membranes in the membrane contactor membrane module (100), but instead the pressure on the hollow fiber membrane outsides was reduced to a gauge pressure of −97 kPa.

The results are shown in Table 2-3.

In Comparative Reference Example 1-1, most of the water in the treatment water migrated to the reduced pressure side making it impossible to continue from 2.5 hours after operation was initiated, and therefore the operation was halted at that point.

TABLE 2-1

| | Treatment water | | | | | | |
|---|---|---|---|---|---|---|---|
| | | | | | | | Inlet |
| | | | | | | | water |
| | Volatile solute | | Non-volatile solute | | Flow | Inlet | vapor |
| | | Concentration | | Concentration | rate | temperature | pressure |
| | Type | (ppm) | Type | (ppm) | (mL/min) | (° C.) | (kPa) |
| Reference Example 1-1 | Ammonia | 300 | NaCl | 1000 | 300 | 50.0 | 12.4 |
| Reference Example 1-2 | Acetic acid | 300 | NaCl | 1000 | 300 | 50.0 | 12.4 |
| Reference Example 1-3 | Methylamine | 300 | NaCl | 1000 | 300 | 50.0 | 12.4 |
| Reference Example 1-4 | Ammonia | 300 | NaCl | 1000 | 300 | 50.0 | 12.4 |
| Reference Example 1-5 | Ammonia | 300 | NaCl | 1000 | 300 | 50.0 | 12.4 |
| Reference Example 1-6 | Ammonia | 300 | NaCl | 1000 | 300 | 50.0 | 12.4 |
| Reference Example 1-7 | Ammonia | 300 | NaCl | 1000 | 300 | 50.0 | 12.4 |
| Reference Example 1-8** | Ammonia | 300 | NaCl | 1000 | 30**⁾ | 50.0 | 12.4 |
| Reference Example 1-9 | Ammonia | 300 | NaCl | 1000 | 300 | 50.0 | 12.4 |
| Reference Example 1-10 | Ammonia | 300 | NaCl | 1000 | 300 | 50.0 | 12.4 |
| Ref. Comp. Example 1-1 | Ammonia | 300 | NaCl | 1000 | 300 | 50.0 | 12.4 |
| Ref. Comp. Example 1-2 | Ammonia | 300 | NaCl | 1000 | 300 | 50.0 | 12.4 |
| Ref. Comp. Example 1-3 | Ammonia | 600 | NaCl | 1000 | 300 | 50.0 | 12.4 |

**⁾For Reference Examples 1-8, the treatment water was flowed in one pass.

TABLE 2-2

| | Absorbing solution | | | | |
|---|---|---|---|---|---|
| | | | | | Inlet water |
| | | | | Inlet | vapor |
| | | Concentration | Flow rate | temperature | pressure |
| | Type | (wt %) | (mL/min) | (° C.) | (kPa) |
| Reference Example 1-1 | H₂SO₄ aq. | 10 | 300 | 42.0 | 7.7 |
| Reference Example 1-2 | NaOH aq. | 10 | 300 | 45.0 | 8.7 |
| Reference Example 1-3 | H₂SO₄ aq. | 10 | 300 | 43.0 | 8.2 |
| Reference Example 1-4 | H₂SO₄ aq. | 10 | 300 | 43.0 | 8.2 |
| Reference Example 1-5 | H₂SO₄ aq. | 10 | 300 | 49.6 | 11.4 |
| Reference Example 1-6 | H₂SO₄ aq. | 10 | 300 | 66.9 | 25.9 |
| Reference Example 1-7 | H₂SO₄ aq. | 10 | 300 | 55.0 | 14.9 |
| Reference Example 1-8 | H₂SO₄ aq. | 10 | 30 | 55.0 | 14.9 |
| Reference Example 1-9 | H₂SO₄ aq. | 10 | 300 | 55.0 | 14.9 |
| Reference Example 1-10 | H₂SO₄ aq. | 10 | 300 | 55.0 | 14.9 |
| Ref. Comp. Example 1-1 | (Reduced pressure) | — | — | — | 4.3 |
| Ref. Comp. Example 1-2 | H₂SO₄ aq. | 10 | 300 | 38.1 | 6.3 |
| Ref. Comp. Example 1-3 | H₂SO₄ aq. | 10 | 600 | 72.5 | 33.0 |

TABLE 2-3

| | | | | Logarithmic | Evaluation results | |
|---|---|---|---|---|---|---|
| | | | Water | mean water | (after 8 h) | |
| | Shape of | | vapor | vapor | Volatile | Absorbing |
| | membrane | | pressure | pressure | solute | solution |
| | contactor | Flow | difference | difference | concentration | amount |
| | membrane | direction | (kPa) | (kPa) | (ppm) | (g) |
| Reference | Hollow fiber | Cocurrent flow | 4.6 | 2.9 | 20 | 1242 |
| Example 1-1 | membrane | | | | | |
| Reference | Hollow fiber | Cocurrent flow | 3.7 | 2.1 | 48 | 1194 |
| Example 1-2 | membrane | | | | | |
| Reference | Hollow fiber | Cocurrent flow | 4.2 | 2.6 | 35 | 1203 |
| Example 1-3 | membrane | | | | | |
| Reference | Flat sheet | Cocurrent flow | 4.2 | 3.3 | 45 | 1056 |
| Example 1-4 | membrane | | | | | |
| Reference | Hollow fiber | Cocurrent flow | 0.9 | 0.9 | 12 | 1008 |
| Example 1-5 | membrane | | | | | |
| Reference | Hollow fiber | Cocurrent flow | −13.5 | −5.3 | 13 | 398 |
| Example 1-6 | membrane | | | | | |
| Reference | Hollow fiber | Cocurrent flow | −2.5 | −1.3 | 8 | 887 |
| Example 1-7 | membrane | | | | | |
| Reference | Hollow fiber | Cocurrent flow | −2.5 | −0.8 | 12 | 988 |
| Example 1-8 | membrane | | | | | |
| Reference | Hollow fiber | Cocurrent flow | −2.5 | −1.4 | 44 | 891 |
| Example 1-9 | membrane | | | | | |
| Reference | Hollow fiber | Cocurrent flow | −2.5 | −1.6 | 7 | 916 |
| Example 1-10 | membrane | | | | | |
| Ref. Comp. | Hollow fiber | Cocurrent flow | 8.1 | 4.4 | 72 | — |
| Example 1-1 | membrane | | | | | |
| Ref. Comp. | Hollow fiber | Cocurrent flow | 6.1 | 3.4 | 64 | 1379 |
| Example 1-2 | membrane | | | | | |
| Ref. Comp. | Hollow fiber | Cocurrent flow | −20.7 | −11.0 | 11 | — |
| Example 1-3 | membrane | | | | | |

In Table 2-2, the listing “H₂SO₄ aq.” in the column “Absorbing solution”, subcolumn “Type” stands for “sulfuric acid aqueous solution”, and “NaOH aq.” stands for “sodium hydroxide aqueous solution”.

### Reference Example 2-1

### (1) Fabrication of Hollow Fiber Membranes for Membrane Contactor

A Henschel mixer was used to mix 23 parts by mass of hydrophobic silica (AEROSIL-R972 by Nippon Aerosil Co., Ltd.) having a mean primary particle size of 0.016 μm and an area-to-weight ratio of 110 m²/g, 31 parts by mass of DOP (di-2-ethylhexyl phthalate-dioctyl phthalate) and 6 parts by mass of DBP (dibutyl phthalate), and then 40 parts by mass of polyvinylidene fluoride (SOLEF^{R} 6010 by Solvay Co.) with a weight-average molecular weight of 310,000 was added, and mixing was resumed with the Henschel mixer. The mixture was further mixed with a twin-screw kneading extruder to obtain pellets.

The obtained pellets were melt kneaded at 240° C. in a twin-screw kneading extruder equipped with a hollow fiber-forming spinneret at the extrusion port, to obtain a molten kneaded material. The obtained molten kneaded material was extruded from the outer ring hole of the hollow fiber-forming spinneret while discharging nitrogen gas from the circular hole on the inside of the spinneret, to cause discharge of a hollow fiber extrusion product from the spinneret. The hollow fiber extrusion product was introduced into a water bath (40° C.) with a run distance of 20 cm, and wound up at a speed of 20 m/min.

The obtained hollow fiber extrusion product was immersed in methylene chloride for extraction removal of the DOP and DBP in the hollow fiber extrusion product, and was dried. After then immersing the hollow fiber extrusion product in a 50 mass % ethyl alcohol aqueous solution, it was immersed for 1 hour in a 5 mass % sodium hydroxide aqueous solution at 40° C., for extraction removal of the silica in the hollow fiber extrusion product.

It was then washed and dried to obtain a polyvinylidene fluoride (PVDF) hollow fiber membrane. The physical properties of the hollow fiber membrane, measured by the methods described above, were as follows.
Inner diameter: 0.68 mm
Outer diameter: 1.25 mm
Membrane thickness: 0.28 mm
Average pore diameter: 0.21 μm
Maximum pore diameter: 0.29 μm
Porosity: 72%
Water contact angle: 103° (hollow fiber membrane outer surface)

### (2) Fabrication of Hollow Fiber Membrane Module

The obtained PVDF hollow fiber membrane was used to fabricate a hollow fiber membrane module having the structure shown in FIG. 2.

A fiber bundle was prepared by bundling 35 hollow fiber membranes cut out to lengths of cm, and was inserted into a housing. A thermosetting epoxy resin was used as the adhesive resin and the membrane bundle was adhesively anchored inside the housing, forming an adhesive resin layer by centrifugal bonding.

This procedure was carried out to fabricate a hollow fiber membrane module having a 8 cm porous length for each hollow fiber membrane (the length of the section not embedded in the adhesive resin layer), and a total area of 60 cm² for the inner surfaces of the hollow fiber membranes.

(3) Adhesion of Hydrophobized Polymer onto Hollow Fiber Membranes (Fabrication of Membrane Contactor Membrane Module)

The fluorine resin-based water repellent “FS1610” by Fluorotechnology Co. (polymer concentration: 1.0 mass %) was injected by a syringe into the hollow sections of the hollow fibers through the treatment water inlet of the hollow fiber membrane module. During the injection procedure, the entire surface insides of the hollow fiber membranes were wetted with the water repellent until the water repellent seeped out from the outsides of the hollow fiber membranes. The excess water repellent was then removed from the hollow fiber membrane module, after which dry air at 25° C. was streamed through the hollow sections of the hollow fiber membranes for overnight drying, to fabricate a membrane contactor membrane module with the entirety of the hollow fiber membranes hydrophobized.

Three such membrane contactor membrane modules were fabricated, one for measurement of pressure loss, one for volatile solute removal, and one for evaluation of the module lifespan.

### (4) Pressure Loss Measurement for Membrane Contactor Membrane Module

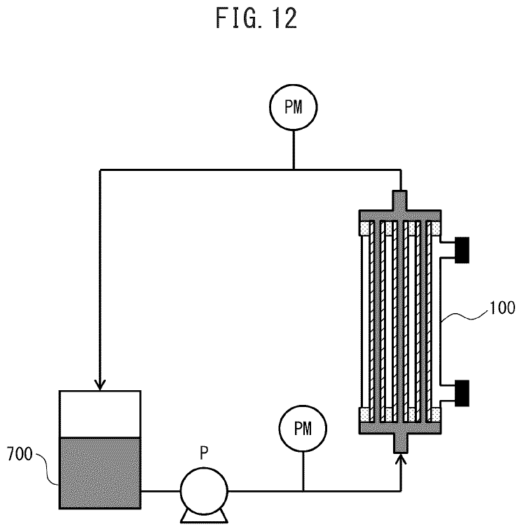

The obtained membrane contactor membrane module was used in an apparatus constructed as shown in FIG. 12 to measure the pressure loss of the membrane contactor membrane module.

With the apparatus of FIG. 12, it is possible to use a membrane contactor membrane module (100) with the absorbing solution inlet and absorbing solution outlet closed off, introducing water in a water tank (700) through the treatment water inlet using a pump (P) and causing it to pass through the hollow sections of the hollow fiber membranes of the membrane contactor membrane module (100) and to be extracted through the treatment water outlet, and then returned to the water tank (700) and recirculated. The inlet side and outlet side of the membrane contactor membrane module (100) may each be provided with a pressure gauge (PM) to allow measurement of the fluid pressure at each location.

The measurement was carried out at 25° C.

The apparatus of FIG. 12 was used to stream water at varying linear velocity into the hollow sections of the hollow fibers of the membrane contactor membrane module, and the fluid pressures at the inlet side and outlet side were examined, recording the pressure loss as their difference and calculating the value of the pressure loss for each linear velocity and Reynolds number. The Reynolds number was calculated assuming a density of 997 kg/m² and a viscosity of 0.00089 Pas for purified water at 25° C.

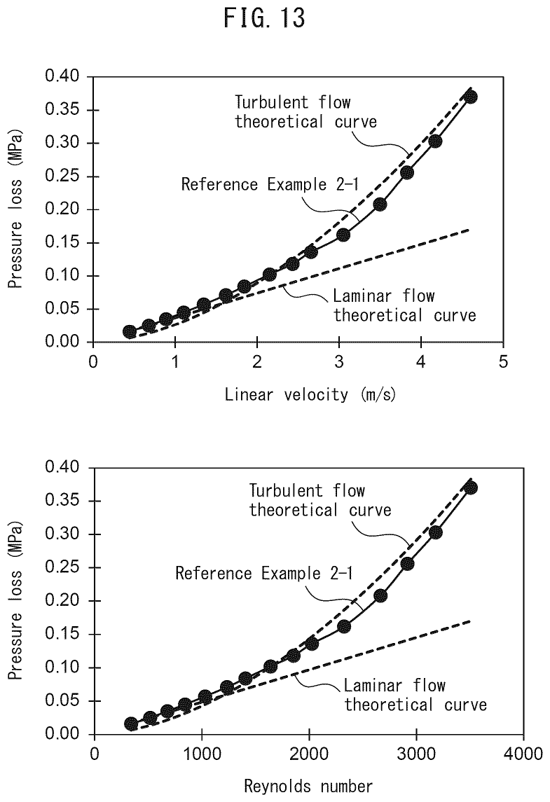

The results are shown in FIG. 13. FIG. 13 shows both theoretical curves, for pressure loss in the case of a laminar flow and in the case of a turbulent flow.

As seen in FIG. 13, pressure loss of the membrane contactor membrane module of Reference Example 2-1 satisfactorily matched the theoretical curve for a laminar flow with a Reynolds number of 1,000 or lower, and satisfactorily matched the theoretical curve for a turbulent flow with a Reynolds number of 1,500 or greater. This results differs from the conventional established theory that a Reynolds number of about 2,300 or lower corresponds to a laminar flow.

### (5) Volatile Solute Removal

The obtained membrane contactor membrane module was incorporated into the volatile solute removal device shown in FIG. 9, and volatile solute removal was carried out.

The volatile solute-containing treatment water and absorbing solution used had the following compositions.

Treatment water: seawater containing 300 ppm ammonia as volatile solute (liquid volume: 1,000 g)

Absorbing solution: 10 mass % concentration sulfuric acid aqueous solution (liquid volume: 1,000 g)

The seawater was collected at a location 2 km offshore from Suruga bay, at a water depth of 1 m. The ammonia was adjusted to a concentration of 300 ppm by addition of 999 g of seawater to 1 g of commercially available ammonia water at a 30 mass % concentration. The major scale component during seawater concentration (CaCO₃) was used as the model compound for calculation of scales.

After filling the treatment water into the treatment water tank (500), the 10 mol/L concentration sodium hydroxide aqueous solution was added dropwise for adjustment to pH 10 or higher.

The treatment water was circulated through the insides of the hollow fiber membranes in the membrane contactor membrane module (100), using a treatment water supply pump (P1) at a flow rate of 750 ml/min. The temperature of the raw water during this time was regulated using a temperature regulator to maintain a temperature of 50° C. at the inlet side of the membrane contactor membrane module (100). The average linear velocity of the treatment water flowing through the interiors of the hollow fiber membranes was 0.98 m/s, and the Reynolds number was 1,142.

Separately, 1,000 g of absorbing solution was filled into the absorbing solution tank (200), and an absorbing solution supply pump (P2) was used for circulation on the outsides of the hollow fiber membranes in the membrane contactor membrane module (100), at a flow rate of 300 mL/min. The temperature of the absorbing solution during this time was regulated using a temperature regulator to maintain a temperature of 50° C. The absorbing solution was flowed into the module in the direction opposite from the treatment water, as shown in FIG. 9.

The volatile solute removal operation was continued for about 8 hours. The water vapor flux and volatile solute flux during the test was as shown in Table 3-2.

The water vapor flux J_{W} (kg/m²·h) and volatile solute flux J_{VS} (g/m²·h) of the membrane contactor were calculated using formulas (9) and (13) to (15) below.

$$\begin{matrix}[ Mathematical Formula 8 ] & \\ {J}_{w} = \frac{{W}_{P}}{A \cdot T} & ( 9 )\end{matrix}$$

$${W}_{P} = {W}_{f}^{0} - {W}_{f} \qquad ( 13 )$$

$${J}_{VS} = \frac{1000 {W}_{VS}}{A \cdot T} \qquad ( 14 )$$

$${W}_{VS} = {W}_{f}^{0} {C}_{VS}^{0} - {W}_{f} {C}_{VS} \qquad ( 15 )$$

In formula (9), W_{P} is the weight (kg) of the permeated vapor, which is equivalent to the value of the initial treatment water weight W_{f}⁰ (kg) minus the raw water weight W_{f}(kg) at about the time of elapse of a fixed time period (formula (13), where A is the membrane area (m²) of the membrane contactor membrane and T is the operating time (h). In formula (14), W_{VS} is the weight (kg) of the permeated volatile solute, which is the value of the initial treatment water weight W_{f}⁰ (kg) multiplied by the initial volatile solute concentration C_{VS}⁰ (wt %), minus the value of the treatment water weight W_{f} (kg) multiplied by the volatile solute concentration C_{VS} (wt %) at about the time of elapse of a fixed time (formula (15)).

In Reference Example 2-1, after 8 hours of operation, the water vapor flux was 1.50 kg/m²·h and the volatile solute (ammonia) flux was 3.58 g/m²·h.

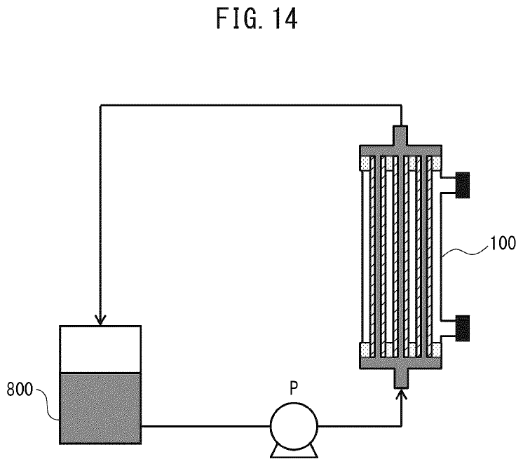

After completion of operation for 8 hours, the membrane contactor membrane module was removed out and installed in the apparatus shown in FIG. 14.

After filling a hydrochloric acid tank (800) with 50 mL of 0.1 M hydrochloric acid as a washing fluid, it was circulated for 1 minute into the hollow portions of the hollow fiber membranes of the membrane contactor membrane module (100) using a pump (P) at a flow rate of 100 mL/min. After 1 minute of circulation, the washing fluid was replaced with fresh hydrochloric acid and circulation was continued for another minute. The same procedure was repeated a total of 5 times.

After circulation, the 5 washing fluids were combined into one, and the calcium ion concentration in the fluid was measured using an ICP-OES analyzer (SPS6100 by Hitachi High-Tech Science).

The resulting value was used to calculate the scale (CaCO₃) deposition amount Ns (mg/m² h), by the following formulas (16) and (17).

$$\begin{matrix}[ Mathematical Formula 9 ] & \\ {N}_{S} = \frac{1000 {m}_{S}}{A \cdot T} & ( 16 )\end{matrix}$$

$${m}_{S} = \frac{{W}_{a} {C}_{i} {M}_{S}}{100 {M}_{i}} \qquad ( 17 )$$

{In formulas (16) and (17), ms is the scale (CaCO₃) deposition amount (g), Wₐ is the total mass (g) of the washing fluid, Cᵢ is the mass percent concentration (wt %) of the cation (Ca²⁺) in the washing fluid, Ms is the molecular weight (g/mol) of the scales (CaCO₃), Mᵢ is the formula weight (g/mol) of the cation (Ca²⁺), A is the membrane area (m²) inside the hollow fiber membranes, and T is the operating time.

The Reynolds number was calculated based on the obtained numerical values, the linear velocity of the treatment water passing through the hollow sections of the hollow fiber membranes of the membrane contactor membrane module during operation of the volatile solute removal device, and the density 1014 kg/m² and viscosity 0.000594 Pas of seawater at 50° C.

Table 3-2 shows the average values for the linear velocity of the treatment water and Reynolds number, the water vapor flux, the volatile solute flux and the amount of deposited scales (CaCO₃), for the volatile solute removal operation described above.

When the membrane contactor membrane module of Reference Example 2-1 was used for volatile solute removal operation under conditions with a Reynolds number of 1,142 and a linear velocity of the treatment water of 0.983 m/s, the amount of scale deposition was only 0.78 mg/m²·h, verifying that essentially no deposition of scales had occurred.

### (6) Measurement of Lifespan

The single remaining membrane contactor membrane module was used to evaluate the lifespan of the membrane contactor membrane module.

First, based on the evaluation results obtained in the volatile solute removal operation described above, the pressure loss was calculated to be 55.0 kPa, when using hollow fiber membranes wherein the lengths L of the hollow fibers were 2,000 times the inner diameters. Formula (8) for the pressure loss with turbulent flow was used for the calculation. This calculation assumes scaling-up of the module.

Volatile solute removal operation was carried out for 24 hours under the same conditions as described above except that the fluid pressure of the treatment water inlet was adjusted to the same value as the calculated pressure loss value, and the initial volatile solute flux value was measured. After operation for 24 hours, the raw liquid was replaced and membrane distillation operation was carried out for 24 hours under the same conditions without washing the hollow fiber membrane. This procedure was repeated, continuing volatile solute removal operation to a total operating time of 1,000 hours.

After operation for 1,000 hours, the volatile solute flux was measured and compared with the initial value, for evaluation on the following scale.
A: Volatile solute flux after 1,000 hours of operation was ≥70% of initial value.
B: Volatile solute flux after 1,000 hours of operation was ≥50% and <70% of initial value.
C: Volatile solute flux after 1,000 hours of operation was <50% of initial value.

In Reference Example 2-1, the volatile solute flux after 1,000 hours of operation was 88% of the initial value, indicating a highly satisfactory result.

### Reference Examples 2-5 to 2-7 and Comparative Reference Examples 2-1, 2-4 and 2-5

Membrane contactor membrane modules were fabricated in the same manner as Reference Example 2-1 except that the treatment water flow rates were as listed in Table 3-1, and each of the properties was evaluated.

The results are shown in Table 3-2.

During evaluation of the lifespan for Comparative Reference Example 2-5, wetting of the hollow fiber membranes occurred at a cumulative operation time of 250 hours, with contamination of the permeated water side by the treatment water, and therefore operation was halted at that point.

### Reference Example 2-2 and Comparative Reference Example 2-2

Membrane contactor membrane modules were fabricated in the same manner as Reference Example 2-1, except that the inner diameters of the hollow fiber membranes were 1.02 mm, the outer diameters were 1.83 mm, and 20 hollow fiber membranes were bundled to form each module.

The pressure loss of the membrane contactor membrane modules was measured in the same manner as “(4) Pressure loss measurement for membrane contactor membrane module” for Reference Example 2-1.

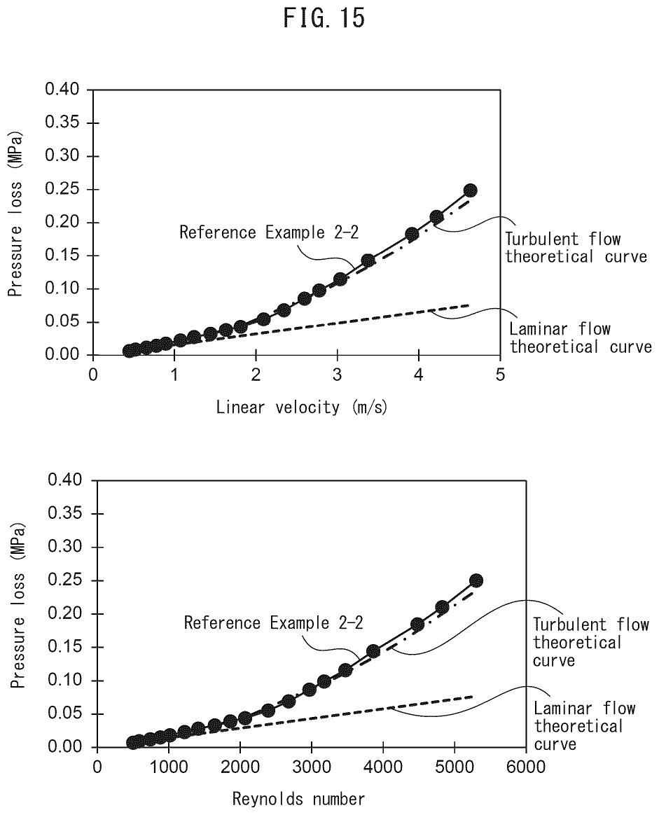

The results are shown in FIG. 15. FIG. 15 shows both theoretical curves, for pressure loss in the case of a laminar flow and in the case of a turbulent flow.

As seen in FIG. 15, pressure loss of the membrane contactor membrane module of Reference Example 2-2 satisfactorily matched the theoretical curve for a laminar flow with a Reynolds number of 1,000 or lower, and satisfactorily matched the theoretical curve for a turbulent flow with a Reynolds number of 1,500 or greater.

Each obtained membrane contactor membrane module was used for volatile solute removal operation in the same manner as Reference Example 2-1, except that the treatment water flow rate was as listed in Table 3-1, and each of the properties was evaluated.

The results are shown in Table 3-2.

### Reference Example 2-3

A membrane contactor membrane module obtained in the same manner as Reference Example 2-1 was incorporated into the volatile solute removal device shown in FIG. 9, and volatile solute removal was carried out.

The volatile solute-containing treatment water and absorbing solution used had the following compositions.

Treatment water: seawater containing 300 ppm acetic acid as volatile solute (liquid volume: 1,000 g)

Absorbing solution: 10 mass % concentration sodium hydroxide aqueous solution (liquid volume: 1,000 g)

The seawater was collected at a location 2 km offshore from Suruga bay, at a water depth of 1 m. The acetic acid was adjusted to a concentration of 300 ppm by addition of 999.7 g of seawater to 0.3 g of commercially available acetic acid at a 100 mass % concentration. The major scale component during seawater concentration (CaCO₃) was used as the model compound for calculation of scales.

After filling the treatment water into the treatment water tank (500), 5 mol/L concentration hydrochloric acid was added dropwise for adjustment to pH 2 or lower.

Volatile solute removal operation was carried out in the same manner as Reference Example 2-1 except for using this treatment water and absorbing solution, and each of the properties was evaluated.

The results are shown in Table 3-2.

### Reference Example 2-4

A membrane contactor membrane module obtained in the same manner as Reference Example 2-1 was incorporated into the volatile solute removal device shown in FIG. 9, and volatile solute removal was carried out.

The volatile solute-containing treatment water and absorbing solution used had the following compositions.

Treatment water: seawater containing 3,000 ppm ethanol as volatile solute (liquid volume: 1,000 g)

Absorbing solution: purified water (liquid volume: 1,000 g)

The seawater was collected at a location 2 km offshore from Suruga bay, at a water depth of 1 m. The ethanol was adjusted to a concentration of 3,000 ppm by addition of 997.0 g of seawater to 3.0 g of commercially available ethanol. The major scale component during seawater concentration (CaCO₃) was used as the model compound for calculation of scales.

Volatile solute removal operation was carried out in the same manner as Reference Example 2-1 except for using this treatment water and absorbing solution, and each of the properties was evaluated.

The results are shown in Table 3-2.

### Comparative Reference Example 2-3

Volatile solute removal operation was carried out in the same manner as Reference Example 2-3 except that the treatment water flow rate was as listed in Table 3-1, and each of the properties was evaluated.

The results are shown in Table 3-2.

TABLE 3-1

| | Membrane contactor membrane module | | | | Treatment water | | | | | |
|---|---|---|---|---|---|---|---|---|---|---|
| | Hollow fiber | | | | | | | | | |
| | membrane | | Number of | Effective | | | | | | Inlet |
| | Inner | Outer | hollow | surface | Volatile solute | | Flow | Linear | | side |
| | diameter | diameter | fiber | area | | Concentration | rate | velocity | Reynolds | temperature |
| | (mm) | (mm) | membranes | (cm²) | Type | (ppm) | (mL/min) | (m/sec) | number | (° C.) |
| Reference Example 2-1 | 0.68 | 1.25 | 35 | 60 | NH₃ | 300 | 750 | 0.98 | 1142 | 50 |
| Reference Example 2-2 | 1.02 | 1.83 | 20 | 51 | NH₃ | 300 | 650 | 0.66 | 1154 | 50 |
| Reference Example 2-3 | 0.68 | 1.25 | 35 | 60 | AcOH | 300 | 750 | 0.98 | 1142 | 50 |
| Reference Example 2-4 | 0.68 | 1.25 | 35 | 60 | EtOH | 3000 | 750 | 0.98 | 1142 | 50 |
| Reference Example 2-5 | 0.68 | 1.25 | 35 | 60 | NH₃ | 300 | 1200 | 1.57 | 1142 | 25 |
| Reference Example 2-6 | 0.68 | 1.25 | 35 | 60 | NH₃ | 300 | 1600 | 2.10 | 2435 | 50 |
| Reference Example 2-7 | 0.68 | 1.25 | 35 | 60 | NH₃ | 300 | 3700 | 4.85 | 5632 | 50 |
| Comp. Ref. Example 2-1 | 0.68 | 1.25 | 35 | 60 | NH₃ | 300 | 400 | 0.52 | 609 | 50 |
| Comp. Ref. Example 2-2 | 1.02 | 1.83 | 20 | 51 | NH₃ | 300 | 350 | 0.36 | 622 | 50 |
| Comp. Ref. Example 2-3 | 0.68 | 1.25 | 35 | 60 | AcOH | 300 | 400 | 0.52 | 609 | 50 |
| Comp. Ref. Example 2-4 | 0.68 | 1.25 | 35 | 60 | NH₃ | 300 | 400 | 0.52 | 1024 | 90 |
| Comp. Ref. Example 2-5 | 0.68 | 1.25 | 35 | 60 | NH₃ | 300 | 4700 | 6.16 | 7154 | 50 |

TABLE 3-2

| | | | Evaluation results | | | | |
|---|---|---|---|---|---|---|---|
| | | | | | Deposition | | |
| | Volatile | | Water | Volatile | scale | Pressure | |
| | solute in | | vapor | solute | (CaCO₃) | loss | |
| | treatment | Absorbing | flux | flux | amount | (L = dP2000) | |
| | water | solution | (kg/m² · h) | (g/m² · h) | (mg/m² · h) | (kPa) | Lifespan |
| Reference Example 2-1 | NH₃ | 10 wt % H₂SO₄ aq. | 1.50 | 3.58 | 0.78 | 55.0 | A |
| Reference Example 2-2 | NH₃ | 10 wt % H₂SO₄ aq. | 1.10 | 3.06 | 1.10 | 24.7 | A |
| Reference Example 2-3 | AcOH | 10 wt % NaOH aq. | 1.09 | 1.10 | 0.63 | 55.0 | A |
| Reference Example 2-4 | EtOH | H₂O | 1.92 | 32.63 | 1.02 | 55.0 | A |
| Reference Example 2-5 | NH₃ | 10 wt % H₂SO₄ aq. | 0.50 | 2.14 | 0.78 | 142.0 | A |
| Reference Example 2-6 | NH₃ | 10 wt % H₂SO₄ aq. | 2.34 | 4.42 | 0.47 | 117.3 | B |
| Reference Example 2-7 | NH₃ | 10 wt % H₂SO₄ aq. | 3.22 | 4.34 | 0.39 | 271.2 | B |
| Comp. Ref. Example 2-1 | NH₃ | 10 wt % H₂SO₄ aq. | 1.04 | 0.66 | 31.31 | 29.3 | C |
| Comp. Ref. Example 2-2 | NH₃ | 10 wt % H₂SO₄ aq. | 0.83 | 0.50 | 27.40 | 13.3 | C |
| Comp. Ref. Example 2-3 | AcOH | 10 wt % NaOH aq. | 0.90 | 0.11 | 21.92 | 29.3 | C |
| Comp. Ref. Example 2-4 | NH₃ | 10 wt % H₂SO₄ aq. | 4.70 | 5.63 | 40.16 | 17.0 | C |
| Comp. Ref. Example 2-5 | NH₃ | 10 wt % H₂SO₄ aq. | 3.76 | 5.42 | 0.23 | 344.5 | C |

In Table 3-2, the listing “H₂SO₄ aq.” in the column “Absorbing solution”, subcolumn “Type” stands for “sulfuric acid aqueous solution”, and “NaOH aq.” stands for “sodium hydroxide aqueous solution”.

### REFERENCE SIGNS LIST

10 Housing
11 Treatment water inlet
12 Treatment water outlet
13 Absorbing solution inlet
14 Absorbing solution outlet
20 Hollow fiber membrane
30 Adhesive resin layer
100, 101 Membrane contactor membrane module
200 Absorbing solution tank
300 Electrodialysis unit
400, 401, 402 Distillation unit
500 Treatment water tank
600 Coalescer
700 Water tank
800 Hydrochloric acid tank
900 Alkali solution tank
1000, 1001, 1002, 1003, 1004, 1005, 1006, 1007 Volatile solute removal device
HE Heat exchanger
P Pump
P1 Treatment water supply pump
P2 Absorbing solution supply pump
V Vacuum pump
TM Thermometer
AS Regenerated absorbing solution
ARS Volatile solute-containing absorbing solution
CW Volatile solute-concentrated water
EL Electrode solution
WW Waste water

1. An ammonia recovery method which includes electrodialysis of a treatment liquid comprising an ammonium salt and an acid to obtain a recovered ammonia water containing ammonia and a recovered acid solution containing an acid, wherein:
the electrodialysis is carried out by a two-chamber method using a bipolar membrane and an anion exchange membrane.

2. The ammonia recovery method according to claim 1, wherein the treatment liquid is a liquid obtained by contacting an ammonia-containing solution with an acid solution to cause the ammonia in the ammonia-containing solution to migrate into the acid solution.

3. The ammonia recovery method according to claim 2, wherein the contact between the ammonia-containing solution and the acid solution is carried out using a membrane contactor.

4. The ammonia recovery method according to claim 3, wherein the membrane of the membrane contactor is a porous hollow fiber membrane.

5. The ammonia recovery method according to claim 4, wherein:
the average pore diameter of the porous hollow fiber membrane is 0.02 μm to 0.5 μm,
the pore size distribution as the ratio of the maximum pore diameter with respect to the average pore diameter is 1.2 to 2.5, and
the porosity of the porous hollow fiber membrane is 60% to 90%.

6. The ammonia recovery method according to claim 4, wherein the treatment liquid is flowed to the inside of the porous hollow fiber membrane and the acid solution is flowed to the outside.

7. The ammonia recovery method according to claim 1, which includes distilling the recovered ammonia water obtained by the electrodialysis to obtain high-concentration ammonia water and distillation residue.

8. The ammonia recovery method according to claim 7, wherein the treatment liquid is a liquid obtained by contacting an ammonia-containing solution with an acid solution to cause the ammonia in the ammonia-containing solution to migrate into the acid solution.

9. The ammonia recovery method according to claim 8, wherein the contact between the ammonia-containing solution and the acid solution is carried out using a membrane contactor.

10. The ammonia recovery method according to claim 9, wherein the membrane of the membrane contactor is a porous hollow fiber membrane.

11. The ammonia recovery method according to claim 10, wherein:
the average pore diameter of the porous hollow fiber membrane is 0.02 μm to 0.5 μm,
the pore size distribution as the ratio of the maximum pore diameter with respect to the average pore diameter is 1.2 to 2.5, and
the porosity of the porous hollow fiber membrane is 60% to 90%.

12. The ammonia recovery method according to claim 11, wherein the treatment liquid is flowed to the inside of the porous hollow fiber membrane and the acid solution is flowed to the outside.

13. The ammonia recovery method according to claim 2, which includes:
distilling the recovered ammonia water obtained by the electrodialysis to obtain high-concentration ammonia water and distillation residue, and
mixing the distillation residue with the ammonia-containing solution.

14. The ammonia recovery method according to claim 13, wherein an alkali is added to the recovered ammonia water before distillation.

15. An ammonia recovery method which includes the following steps in order:
(A) distilling ammonia-containing waste water to obtain recovered ammonia and an ammonia-containing solution as a first distillation residue,
(B) contacting the ammonia-containing solution with an acid solution to cause the ammonia in the ammonia-containing solution to migrate into the acid solution and obtain a treatment liquid,
(C) subjecting the treatment liquid to electrodialysis to obtain a recovered ammonia water containing ammonia and a recovered acid solution containing an acid, and
(D) distilling the recovered ammonia water to obtain high-concentration ammonia water and a second distillation residue.

16. The ammonia recovery method according to claim 15, wherein steps (A) to (D) are carried out in a cyclical manner.
